(19) United States
(12) Patent Application Publication
(10) Pub. No.: US 2023/0215103 A1
(43) Pub. Date: Jul. 6, 2023

(54) AUTOMATED PANORAMIC IMAGE CONNECTIONS FROM OUTDOOR TO INDOOR ENVIRONMENTS

(71) Applicant: Threshold 360, Inc., Tampa, FL (US)

(72) Inventors: Sean Kovacs, Tampa, FL (US); Joshua Paine, Tampa, FL (US); Jordan Raynor, Tampa, FL (US); Daniel Kraus, Tampa, FL (US)

(73) Assignee: Threshold 360, Inc., Tampa, FL (US)

(21) Appl. No.: 18/091,533

(22) Filed: Dec. 30, 2022

Related U.S. Application Data
(60) Provisional application No. 63/295,314, filed on Dec. 30, 2021.
(60) Provisional application No. 63/295,310, filed on Dec. 30, 2021.
(60) Provisional application No. 63/294,914, filed on Dec. 30, 2021.

(51) Int. Cl. G06T 19/00; G06T 13/20; G06V 10/70; H04N 23/698; G06F 16/587

(52) U.S. Cl. CPC G06T 19/003; G06T 13/20; G06V 10/70; H04N 23/698; G06F 16/587

(57) ABSTRACT

Automated panoramic image connections from outdoor to indoor environments is provided. A system identifies, in a data repository, a virtual tour of an internal portion of a physical building formed from a plurality of images connected with a linear path along a persistent position of a virtual camera. The system receives, from a third-party data repository, image data corresponding to an external portion of the physical building. The system detects, within the image data, an entry point for the internal portion of the physical building. The system generates, responsive to the detection, a step-in transition at the entry point in the image data. The system connects the virtual tour with the step-in transition generated for the image data at the entry point. The system initiates, on a client device responsive to an interaction with the entry point, the step-in transition to cause a stream of the virtual tour.

### CROSS-REFERENCES TO RELATED APPLICATIONS

This application claims the benefit of priority under 35 U.S.C. § 119 to U.S. Provisional Patent Application No. 63/294,914, filed Dec. 30, 2021, which is hereby incorporated by reference herein in its entirety. This application also claims the benefit of priority under 35 U.S.C. § 119 to U.S. Provisional Patent Application No. 63/295,310, filed Dec. 30, 2021, which is hereby incorporated by reference herein in its entirety. This application also claims the benefit of priority under 35 U.S.C. § 119 to U.S. Provisional Patent Application No. 63/295,314, filed Dec. 30, 2021, which is hereby incorporated by reference herein in its entirety.

### FIELD OF THE DISCLOSURE

This disclosure generally relates to automatically connecting external data and internal image data to generate a step in transition.

### BACKGROUND

A third party database can provide location data in the form of image data or geoposition data. However, due to technical challenges associated with processing and synchronizing the data, it can be challenging to connect image data from a third party database for an outdoor environment with images from a different database for an indoor environment.

### SUMMARY OF THE DISCLOSURE

Systems and methods of this technical solution are generally directed to automatically connecting external data that can be captured from a client device and internal image data to generate a step in transition. This technical solution can automatically detect an entry point from location data from third party databases by connecting, or comparing and syncing, the third party data and data from an internal database to generate a smooth, seamless step in transition. This technical solution can then integrate the generated step in transition into a virtual tour. Thus, this technical solution can connect external data, which can be captured from a client device, and internal image data to generate a step in transition that is a cohesive experience that is based on a cohesive set of rules. The generated step in transition can be provided to a viewer application for rendering or playback to a user.

For example, a third party database can provide location data in the form of image data or geoposition data. However, due to constraints associated with recognition software, it can be challenging to detect an entry point. Further, due to constraints associated with recognition software, it can be challenging to detect the best, or correct, entry point in the case that there are multiple entry points detected. Additionally, due to constraints associated with recognition software, it can be challenging to create an entry point if no entry point was detected. Moreover, due to constraints associated with data sync errors, it can be challenging to sync internal image data and the third party data. Further, due to constraints associated with data sync errors, it can be challenging to avoid or limit spatial disorientation.

Thus, this technical solution an include a system configured with technical rules and logic to provide bidirectional camera movement with specific constraints that allow for only forwards or backwards movement along the camera path (e.g., a linear path), thereby disabling branching off the camera paths. By disabling or preventing branching along the camera path, the system can reduce excess computing resource utilization, while providing a smooth step in transition. The system can be configured with rules and logic to control the speed of the playback and the step in transition. For example, the system can maintain a constant speed of playback and step in transition. In some cases, the system can allow a user to set the speed of the playback in a configuration file, and then render the step in transition using the constant speed set by the user.

The viewer application rendering the step in transition can present graphical user elements along with the playback. For example, the viewer application can provide interactive icons on doors that a user can select or otherwise interact with in order to step into an entrance. The system (e.g., the viewer application or via the viewer application), can be configured to receive, intercept or detect user input during the step in transition. The system can be configured with an interrupt detection component that can detect the user input and identify a command or instruction to engage or interact with a component of step in transition. For example, the system can allow for dynamic interaction or manipulation of a 360 degree scene or image.

An aspect of this disclosure can be directed to a system. The system connect outdoor-to-indoor panoramic data. The system can include a data processing system comprising one or more processors, coupled with memory. The data processing system can identify, in a data repository, a virtual tour of an internal portion of a physical building formed from a plurality of images connected with a linear path along a persistent position of a virtual camera. The data processing system can receive, from a third-party data repository, image data corresponding to an external portion of the physical building. The data processing system can detect, within the image data, an entry point for the internal portion of the physical building. The data processing system can generate, responsive to the detection of the entry point, a step-in transition at the entry point in the image data. The data processing system can connect the virtual tour with the step-in transition generated for the image data at the entry point. The data processing system can initiate, on a client device responsive to an interaction with the entry point, the step-in transition to cause a stream of the virtual tour.

The data processing system can determine a location of the physical building of the virtual tour. The data processing system can query the third-party data repository with the location. The data processing system can receive, from the third-party data repository, the image data responsive to the query.

The data processing system can identify a plurality of entry points in the image data. The data processing system can provide a prompt to a second client device to select one entry point from the plurality of entry points for which to generate the step-in transition.

The data processing system can cast rays to corner points of one or more doors in the image data to identify a cube face of a plurality of cube faces. The data processing system can assign the entry point to a door of the one or more doors corresponding to the identified cube face of the plurality of cube faces. In some implementations, the data processing system can provide, responsive to selection of the door of the one or more doors, a set of sprites to form an outline for the door. The data processing system can generate a step-in animation for the step-in transition based on the set of sprites. The data processing system can integrate the step-in animation with the virtual tour. In some implementations, the data processing system can overlay an icon on the image data to generate the step-in animation.

The data processing system can deliver, responsive to the interaction with the entry point by the client device, a viewer application that executes in a client application on the client device. The data processing system can stream, to the viewer application, the virtual tour to cause the viewer application to automatically initiate playback of the virtual tour upon receipt of the streamed virtual tour.

The data processing system can receive, from the third-party data repository, data corresponding to the external portion of the physical building. The data processing system can iterate through the data from the third-party data repository to identify key datasets from image-level noise in the data. The data processing system can correlate the plurality of images from the data repository with the key datasets of the third-party data repository to identify the image data comprising the entry point. In some implementations, the data processing system can use machine learning to correlate the plurality of images of the data repository with the key datasets of the third-party data repository to identify the image data comprising the entry point.

The data processing system can identify a door in the image data based on machine learning with saved images. The data processing system can detect the entry point as the door.

An aspect of this disclosure can be directed to a method of connecting outdoor-to-indoor panoramic data. The method can be performed by a data processing system one or more processors coupled with memory. The method can include the data processing system identifying, in a data repository, a virtual tour of an internal portion of a physical building formed from a plurality of images connected with a linear path along a persistent position of a virtual camera. The method can include the data processing system receiving, from a third-party data repository, image data corresponding to an external portion of the physical building. The method can include the data processing system detecting, within the image data, an entry point for the internal portion of the physical building. The method can include the data processing system generating, responsive to the detection of the entry point, a step-in transition at the entry point in the image data. The method can include the data processing system connecting the virtual tour with the step-in transition generated for the image data at the entry point. The method can include the data processing system initiating, on a client device responsive to an interaction with the entry point, the step-in transition to cause a stream of the virtual tour.

An aspect of this disclosure can be directed to a non-transitory computer readable medium storing processor-executable instructions. The instructions, when executed by one or more processors, can cause the one or more processors to: identify, in a data repository, a virtual tour of an internal portion of a physical building formed from a plurality of images connected with a linear path along a persistent position of a virtual camera. The instructions can cause the one or more processors to receive, from a third-party data repository, image data corresponding to an external portion of the physical building. The instructions can cause the one or more processors to detect, within the image data, an entry point for the internal portion of the physical building. The instructions can cause the one or more processors to generate, responsive to the detection of the entry point, a step-in transition at the entry point in the image data. The instructions can cause the one or more processors to connect the virtual tour with the step-in transition generated for the image data at the entry point. The instructions can cause the one or more processors to initiate, on a client device responsive to an interaction with the entry point, the step-in transition to cause a stream of the virtual tour.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims

FIG. 1 depicts a block diagram of an illustrative system to connect external data and internal image data to generate a step in transition which can be integrated into a virtual tour, in accordance with an implementation.

FIGS. 2A-2H depict illustrations of various commercial venue entryways on third party databases, in accordance with implementations.

FIGS. 21 and 2J depict illustrations of the interactive icon generated to facilitate the step in transition.

FIG. 3 is a block diagram illustrating an architecture for a computer system that can be employed to implement elements of the systems, flows and methods described and illustrated herein.

FIG. 4 depicts an illustration of a virtual tour generated by a data processing system, in accordance with implementations.

FIG. 5 depicts an example method for connecting external data and internal image data to generate a step in transition which can be integrated into a virtual tour, in accordance with an implementation.

FIG. 6 depicts a block diagram of an illustrative system for connecting customer provided locations and capture participants, e.g., photographers, to provide the on-demand capture of location attributes, in accordance with implementations.

FIG. 7A depicts a flowchart of the location attribute capture process, in accordance with implementations.

FIG. 7B depicts an illustration of multiple locations a customer may have to schedule captures for, in accordance with implementations.

FIG. 8 depicts a flowchart of the scheduling flow process from the users' views, in accordance with implementations.

FIG. 9 depicts a flowchart of the scheduling flow process, in accordance with implementations.

FIG. 10 depicts a flowchart of the scheduling flow process from the data's view, in accordance with implementations.

FIG. 11 depicts a flowchart of the scheduling flow process from a stack view, in accordance with implementations.

FIG. 12 depicts a block diagram of an illustrative system for registering and referencing images and/or a sequence of images on a digitally distributed, decentralized, public or private ledger, in accordance with an embodiment.

FIG. 13 depicts an example method of performing registration of and reference to images and/or a sequence of images on a digitally distributed, decentralized, public or private ledger, in accordance with an embodiment.

### DETAILED DESCRIPTION

Systems and methods of this technical solution are generally directed to automatically connecting external data, which can be captured from a client device, and internal image data to generate a step in transition. This technical solution can automatically detect an entrance by connecting, or syncing and comparing, external data and internal data to generate a seamless step in transition. The technical solution can integrate the generated step in transition into a virtual tour. Thus, this technical solution can connect and transition between external and internal data to create a cohesive experience that is based on a cohesive set of rules.

To do so, the data processing system of this technical solution can receive and record geoposition data or image data, such as independent panoramic images, video, or GPS coordinates, from a third party database. The data processing system can use iteration to surface key datasets from image-level noise, and then sync and compare the third party data and internal image data via a step in location correlator. The data processing system can be configured with a step in detection technique to facilitate generating the step in transition. The data processing system can be configured with one or more step in detection techniques, including, for example, a scale-invariant feature transform (“SIFT”), speeded up robust features (“SURF”), AKAZE, or BRISK. The data processing system can use a combination of octave and octave layers, scale factor, sigma values, and feature limiters to extract the target datasets.

The data processing system can further automatically generate step in transitions that can be integrated into the virtual tour. For example, depending on the geoposition data from the third party database, different effects can be generated. The data processing system can provide a step in animation through a door or archway from outside to inside, inside to outside, outside to outside, and/or inside to inside. The step in transition can be integrated into the virtual tour.

The virtual tour is created by automatically connecting panoramic images by associating a visual position and direction between correlative panoramic images or video media to generate a smooth, seamless camera path between the different panoramic images. The generated camera path is used to generate a virtual tour.

To do so, the data processing system of this technical solution can receive independent panoramic images or video from a client device. The data processing system can use iteration to surface key datasets from image-level noise, and create a directional connection between the panoramic images. The data processing system can be configured with a feature detection technique to facilitate generating the virtual tours. The data processing system can be configured with one or more feature detection technique, including, for example, a scale-invariant feature transform (“SIFT”), speeded up robust features (“SURF”), AKAZE, or BRISK. The data processing system can use a combination of octave and octave layers, scale factor, sigma values, and feature limiters to extract the target datasets.

To facilitate generating virtual tours, the data processing system can explicitly control and persist digital camera position to connect a set of panoramic images. The data processing system can register, visually associate, and persist the order of a set of panoramic media so as to create a virtual tour.

The data processing system can further automatically generate characteristics for the virtual tour. For example, the data processing system can provide a linear directional method that constraints the virtual tour camera path to forwards and backwards. The data processing system can provide an animation where each step through a sequence can begin with an automated camera pan—on one or both sides. The data processing system can provide an interruptible interactive experience, such as the ability to lean-back or lean-forward. As part of the transition, the data processing system can provide a method for camera control editing camera position.

The data processing system can provide a method for establishing key camera pose or bearing for the sake of panoramic connection. To do so, the data processing system can determine the pose or bearing of cameras given current registration as seen by another image. The data processing system can use the bearing information to author the direction of travel. To determine the bearings, the data processing system can be configured with a pose extraction technique. The pose extraction technique can include or be based on an comparing or fading two images, and identifying or finding the camera position based on the second image. The data processing system can perform pose extraction by handling spherical or epipolar geometry, in addition to flat images, and can provide fully-automated direct connection (automated).

Thus, the data processing system of this technical solution can establish a balance between automatic playback and interruptability of a virtual tour that is constrained to forwards/backwards movement without any branching. The data processing system can automatically connect panoramic images and can prioritize the camera path in order to generate the virtual tour with a fixed speed (e.g., 3 seconds per image). The data processing system can be configured with a machine learning technique to automatically align images. For example, the data processing system can use machine learning to make use of saved data, such as images of doors, to regularly refine and improve the image correlation. The machine learning program can identify an object, e.g., a door, as a digital image based on the intensity of the pixels in black and white images or color images. The machine learning program can identify objects, such as doors, with more reliability over time because it leverages the objects, e.g., doors, it already identified. Likewise, the machine learning program can match images of doors from third party databases with images of doors from internal databases more reliably over time because it leverages the matches it already identified. At connection time, the data processing system can provide an option to change path or pan to render another frame. For example, the data processing system can generate the virtual tour with a camera path that can automatically turn left or right. The data processing system can automatically generate characteristics for inclusion in the virtual tour, including, for example, chevrons or other icons that indicate directionality or interactivity. The chevron-style control provided by the data processing system can move the virtual tour in a linear direction, such as uniquely back and forth, through the tour.

For example, the data processing system can deliver a viewer application for rendering in a client application (e.g., a web browser) on a client device (e.g., laptop computing device, tablet computing device, smartphone, etc.). The data processing system can provide the viewer application responsive to a request or call from the client device. The data processing system can stream content that includes the panoramic images and metadata on the panoramic images. The viewer application executing on the client device can automatically initiate playback of the virtual tour upon receipt of the streamlining content, and provide a control interface for the user to control certain aspects of the virtual tour during playback.

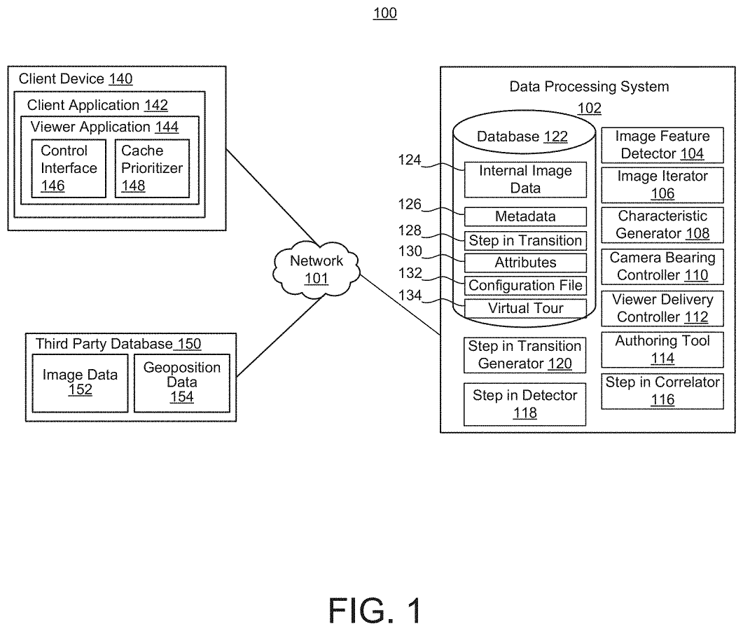

FIG. 1 depicts a block diagram of an illustrative system to connect external geoposition data, which can be captured from a client device, and internal image data to generate a step in transition which can be integrated into a virtual tour, in accordance with an implementation. The system 100 can include a data processing system 102 designed, constructed and operational to receive images and geoposition data, process the images and geoposition data, and connect the images and geoposition data to internal image data to generate a step in transition, which can be integrated into a virtual tour. The data processing system 102 can include one or more processors, servers, or other hardware components depicted in FIG. 3. The data processing system 102 can include at least one image feature detector 104. The data processing system 102 can include at least one image iterator 106. The data processing system 102 can include at least one characteristic generator 108. The data processing system 102 can include at least one camera bearing controller 110. The data processing system 102 can include at least one viewer delivery controller 112. The data processing system 102 can include at least one authoring tool 114. The data processing system can include at least one step in correlator 116. The data processing system can include at least one step in detector 118. The data processing system can include at least one step in transition generator 120. The data processing system 102 can include at least one database 122. The database 122 can store internal image data 124 and a configuration file 132. The internal image data 124 can include internal data, such as different types of doors and archways. The database 122 can include or store metadata 126 associated with the internal image data 124, step in transitions, or virtual tours. The database 122 can include or store step in transitions 128 generated by the data processing system 102. The database 122 can include or store virtual tours 134 generated by the data processing system 102. The database 122 can include or store attributes 130.

One or more of the image feature detector 104, image iterator 106, characteristic generator 108, camera bearing controller 110, viewer delivery controller 112, authoring tool 114, step in correlator 116, step in detector 118, or step in transition generator 120 can include one or more processors, logic, rules, software or hardware. One or more of the image feature detector 104, image iterator 106, characteristic generator 108, camera bearing controller 110, viewer delivery controller 112, authoring tool 114, step in correlator 116, step in detector 118, or step in transition generator 120 can communicate or interface with one or more of the other component of the data processing system 102 or system 100.

The data processing system 102 can interface or communicate with at least one third party database 150 via a network 101. The third party database 150 can include external data. For example, image data 152 and geoposition data 154. The third party database 150 can transmit images from the image data 152 to the data processing system 102 via network 101. The third party database 150 can transmit location information, such as latitude and longitude coordinates and/or addresses, from the geoposition data 154 to the data processing system 102 via network 101. The addresses from the geoposition data 154 can be associated with a variety of noncommercial and commercial structures, such as, event centers, stadiums, malls, hotels, restaurants, or real estate. The database 122 can include or store metadata 126 associated with the image data 152 or geoposition data 154.

Still referring to FIG. 1, and in further detail, the data processing system 102 can include an image iterator 106 designed, constructed and operational to surface key data sets from image-level noise. The image iterator 106 can be configured with one or more techniques to identify key data sets from the image-level noise. The image iterator 106, using these techniques, can create a directional connection between the images. For example, the image iterator 106 can access internal image data 124 stored in database 122, process the images to remove image-level noise, and then determine a directional connection between the images. A directional connection can refer to a camera path or transition from a first image to a second image. The image iterator 106 can control and persist a digital camera position through the panoramic connection set.

Further, the image iterator 106, using the techniques to identify key data sets from the image-level noise, can create a set of key data sets. For example, the image iterator 106 can access image data 152 or geoposition data 154 stored in database 122 via metadata 126, process the images to remove image-level noise, and then create a set of key data.

The image iterator 106 can establish, set, generate or otherwise provide image transitions for the virtual tour. The data processing system can build visual image transitions during the creation of the virtual tour. To do so, the data processing system 102 can use a tweened animation curve. A tweened animation curve can include generating intermediate frames between two frames in order to create the illusion of movement by smoothly transitioning one image to another. The data processing system 102 can use the tweened animation curve to increase or maximize the sense of forward motion between images, relative to not using tweened animations.

The image iterator 106 can perform tweening in a manner that preserves the spatial orientation. For example, the data processing system 102 can position a virtual camera at an entrance of a cube, such as a second cube. The data processing system 102 can move a previous scene forwards and past the viewer while fading out, and move the second scene in (e.g., overlapping) while fading in. This overlap can correspond to, refer to, represent, or symbolize linear editing techniques. For a door transition, the data processing system 102 can fade the door as the viewer passes through the door. Thus, the virtual camera position can persistent in a same position throughout the transition from one iteration of the image to the next.

Thus, the data processing system 102 can receive, from the third-party data repository or database 150, image data 152 corresponding to the external portion of the physical building. The data processing system 102 can iterate through the image data 152 from the third-party data repository 150 to identify key datasets from image-level noise in the image data 152. The data processing system 102 can correlate the plurality of images (e.g., internal image data 124) from the data repository 122 with the key datasets of the third-party data repository 150 to identify the 152 image data comprising the entry point. The data processing system 102 can use machine learning to correlate the plurality of images of the data repository with the key datasets of the third-party data repository to identify the image data comprising the entry point.

The data processing system 102 can include an image feature detector 104 designed, constructed and operational to identify features from the images or sequence of the images. The feature detector can be configured with various feature detection techniques, including, for example, one or more of SIFT, SURF, AKAZE, and BRISK. The image feature detector 104 can use a combination of octave and octave layers, scale factors, sigma values, and feature limiters to extract the target data sets. For example, the image feature detector 104 can receive the key data sets surfaced from image-level noise by the image iterator 106, and then detect features in the key data sets.

The image feature detector 104 can perform image processing on the images to identify features or objects. For example, the image feature detector 104 can detect doors. The data processing system 102 can cast rays to corner points of the door and determine which faces are identified or hit. Since door images can be spread on up to four different cube faces, for example, the data processing system 102 casts the rays to the corner points to identify which faces are hit. The data processing system 102 can then dynamically create an alpha mask in a canvas based on those coordinates. The data processing system 102 can apply this alpha mask to the texture of the cube faces. In some cases, the data processing system 102 can initiate binary searching along the distance between dots, and draw lines to the edge of the face for as many faces involved as necessary. Upon identifying the doors, the data processing system 102 can provide animations for the outline of the door. The data processing system 102 can provide a set of sprites, such as a computer graphic that can be moved on-screen or otherwise manipulated as a single entity. The data processing system 102 can provide the set of sprites around the door outline to form the frame of the door. The data processing system 102 can scale the animation logic in size or opacity.

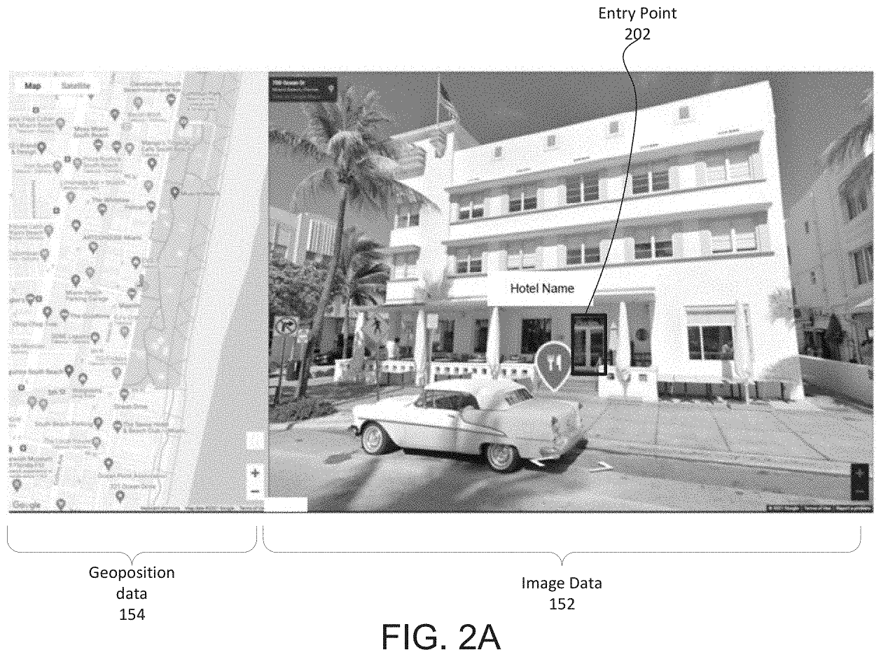

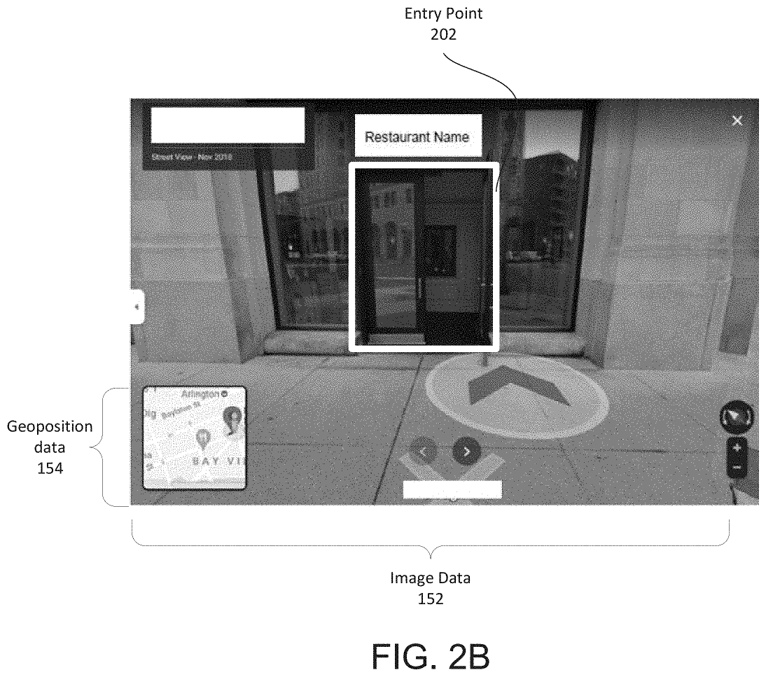

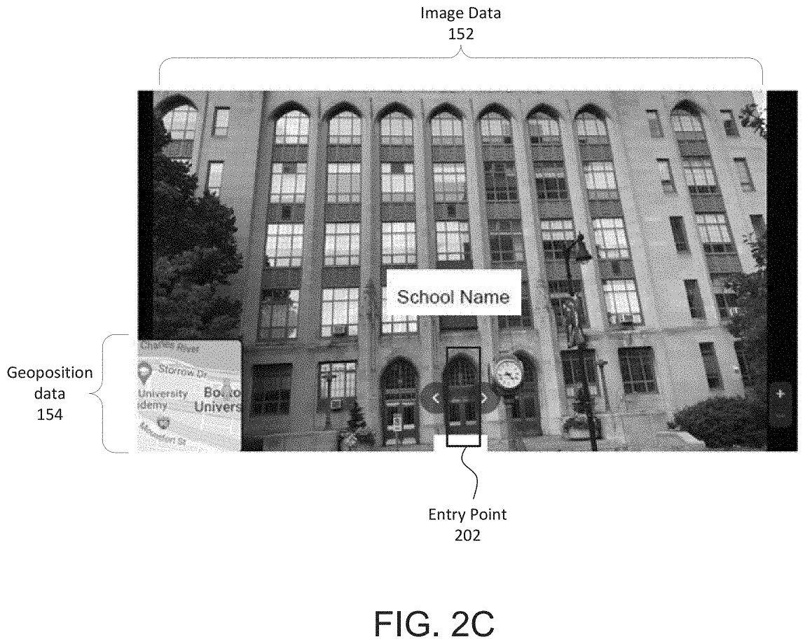

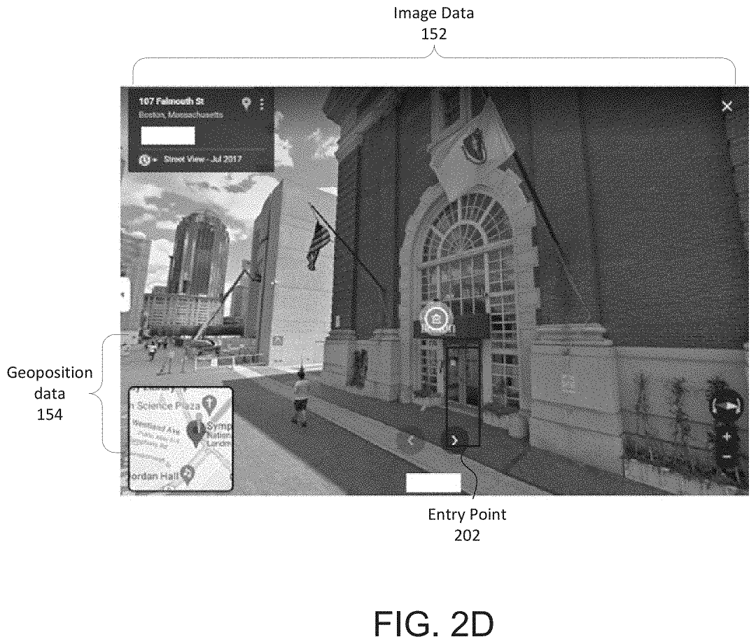

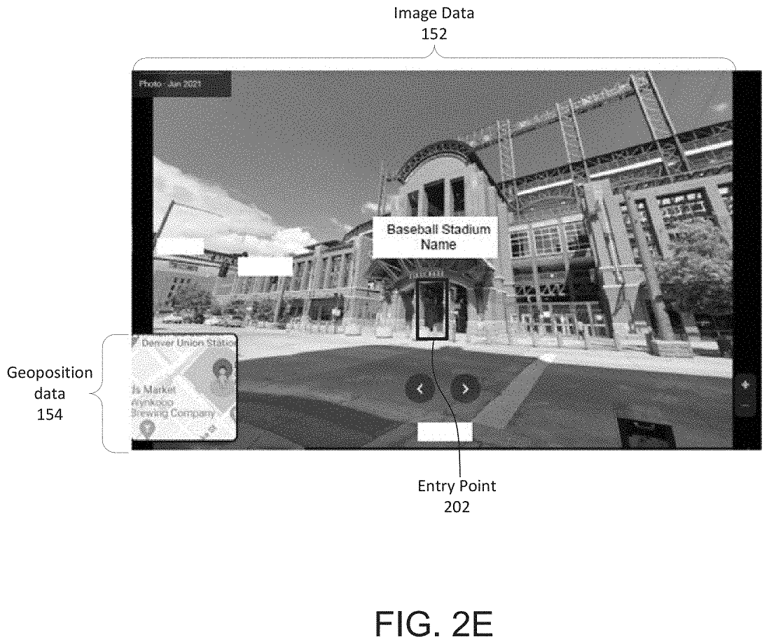

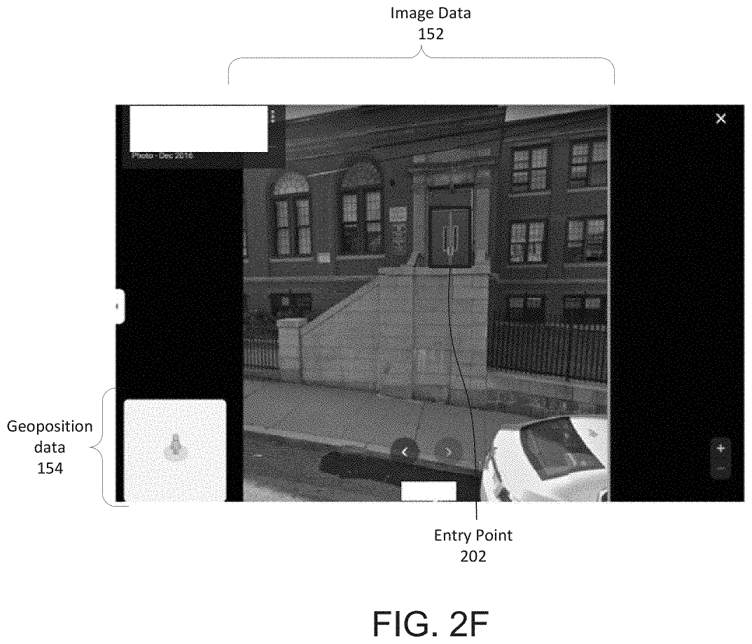

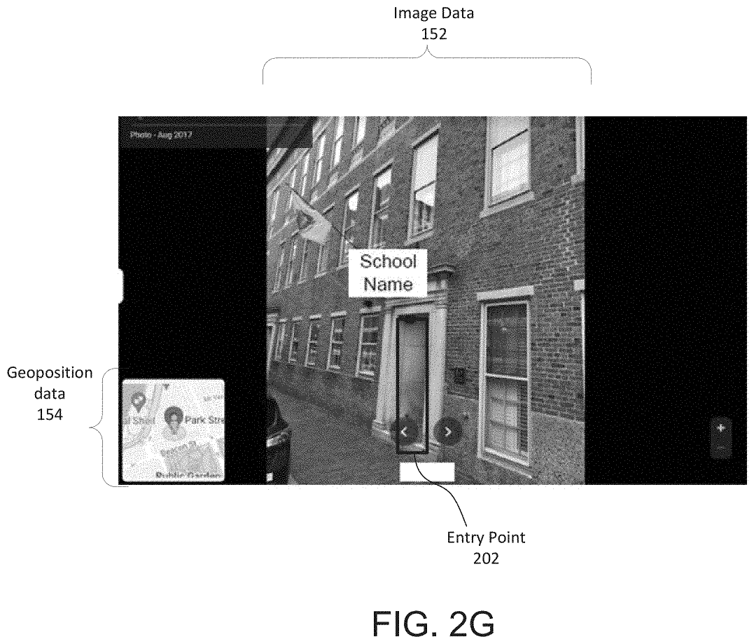

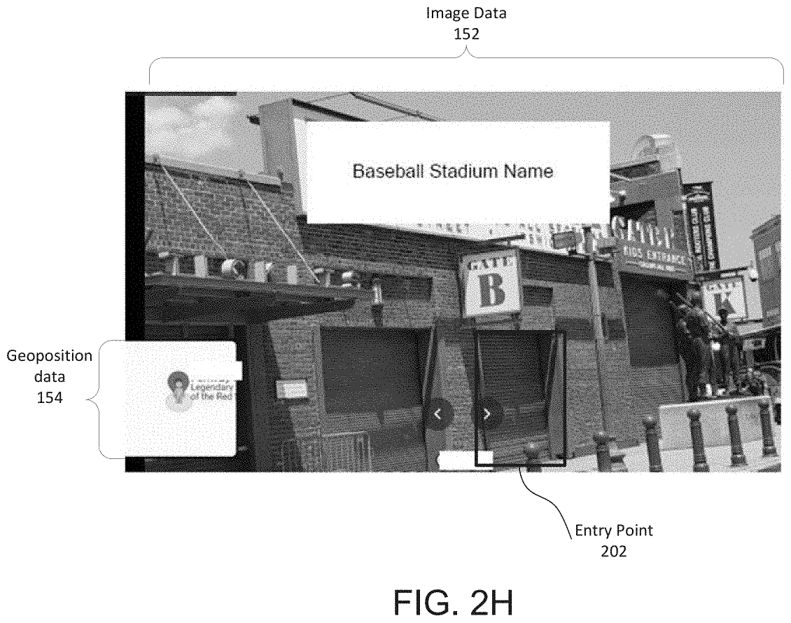

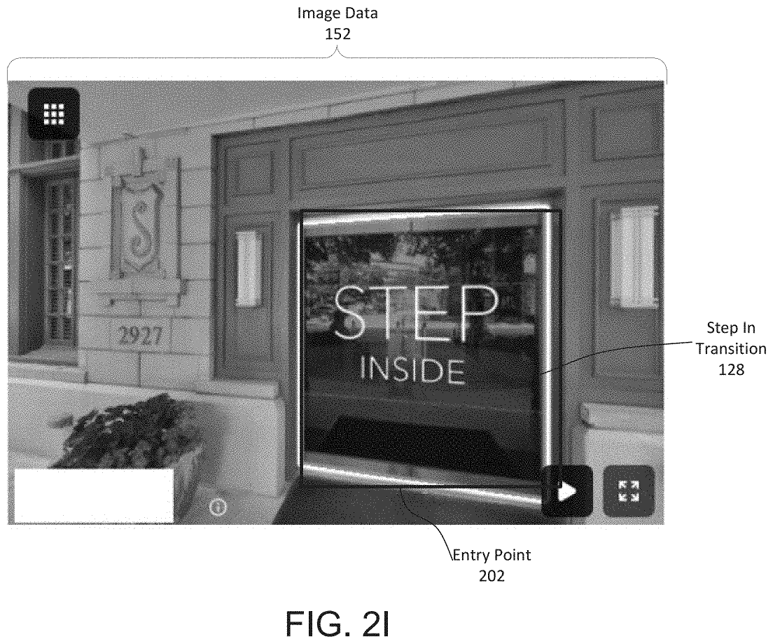

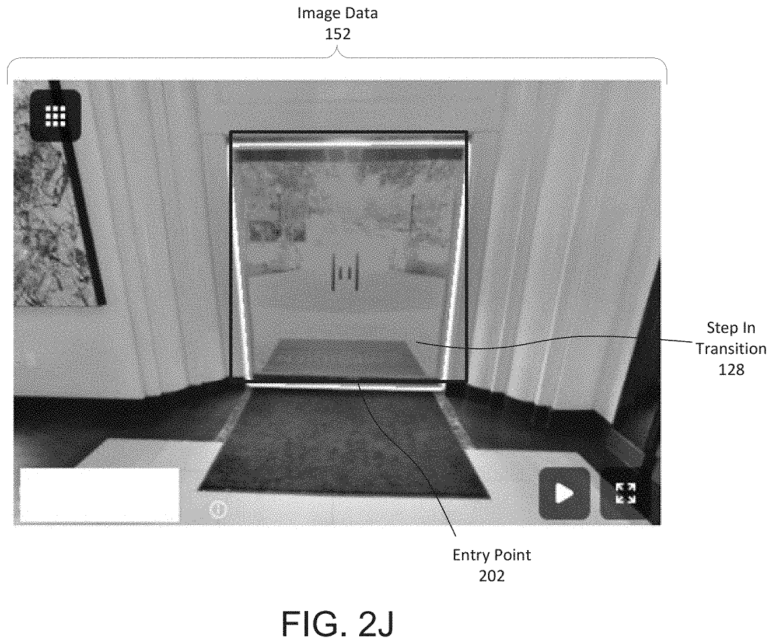

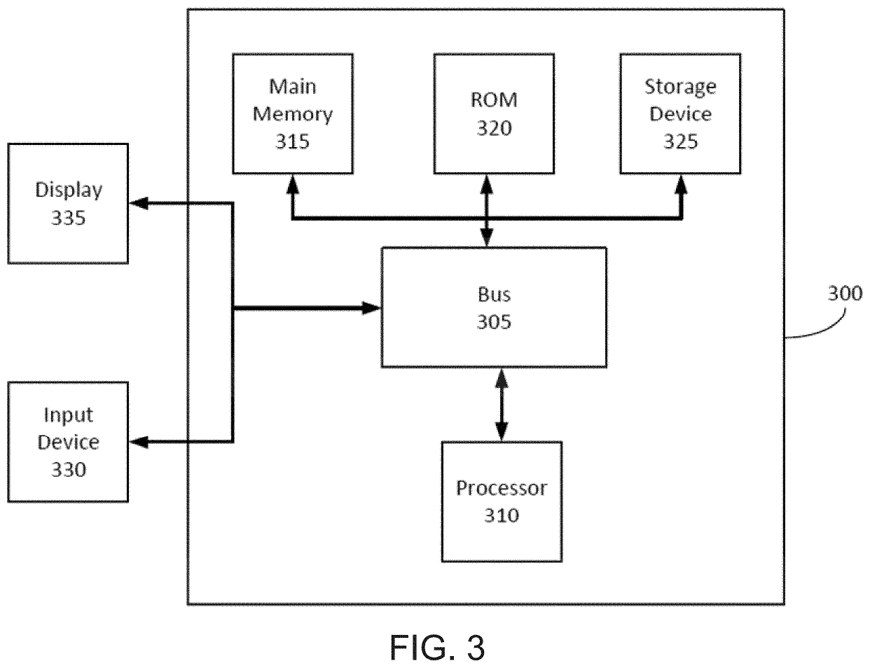

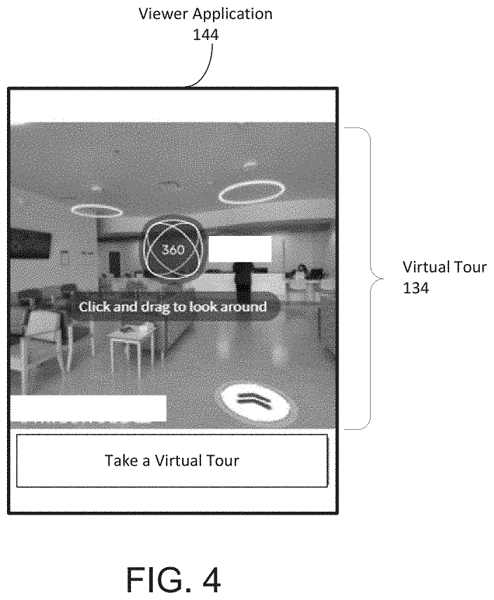

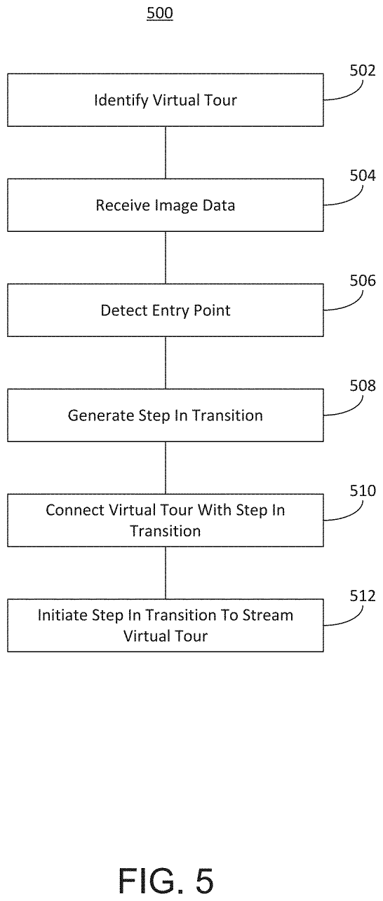

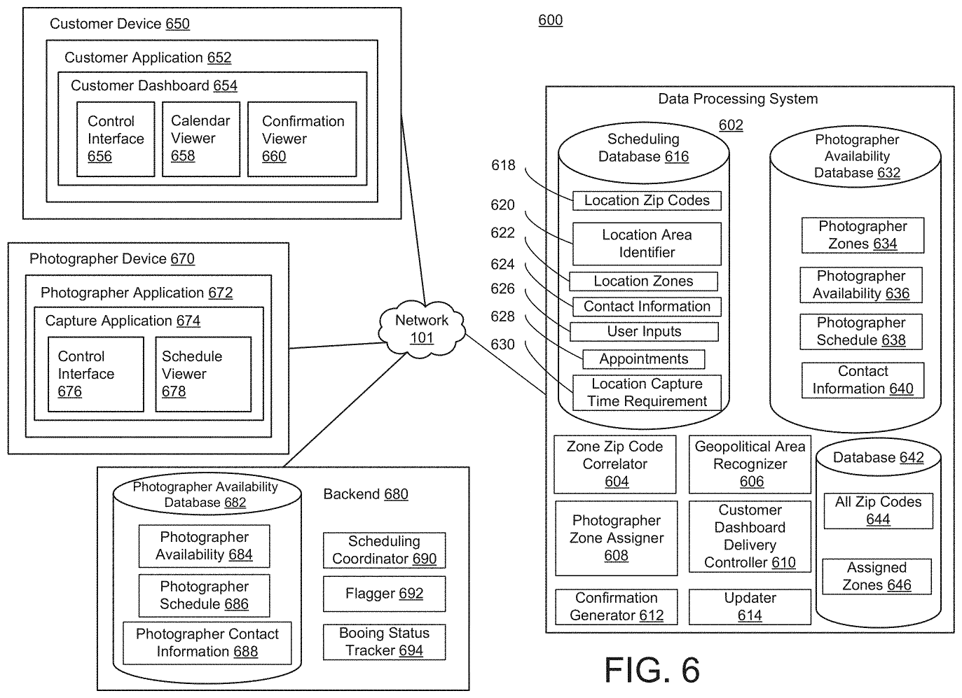

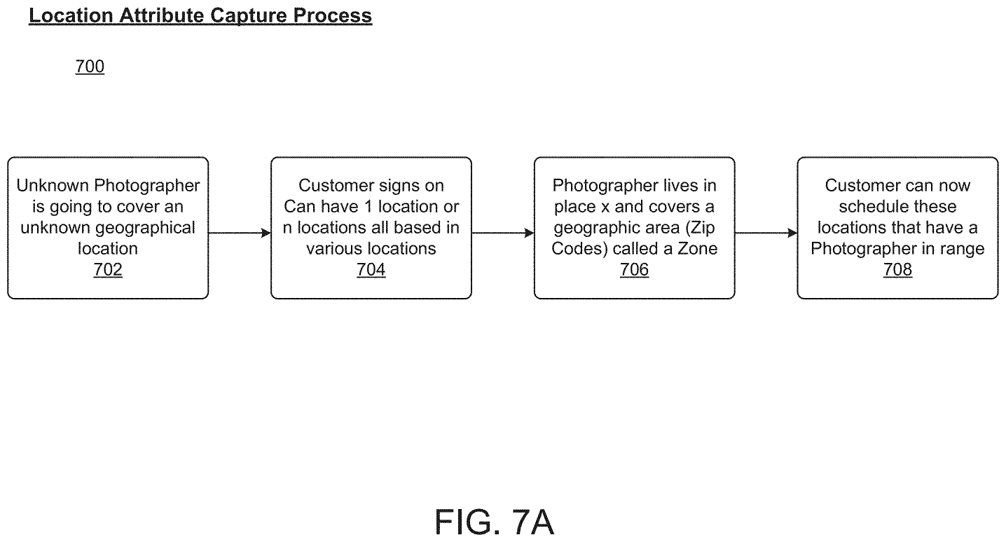

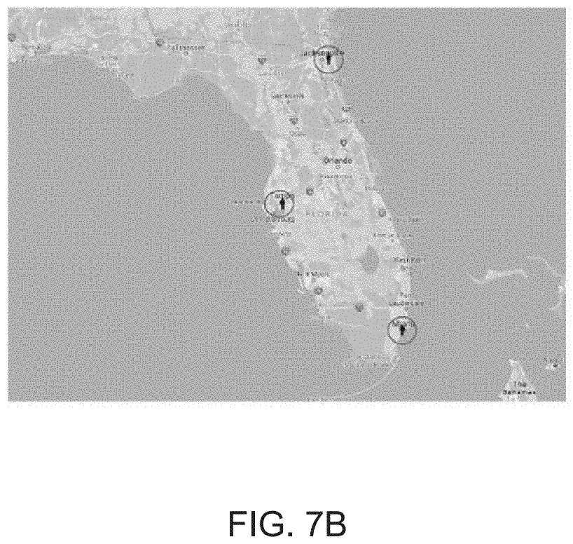

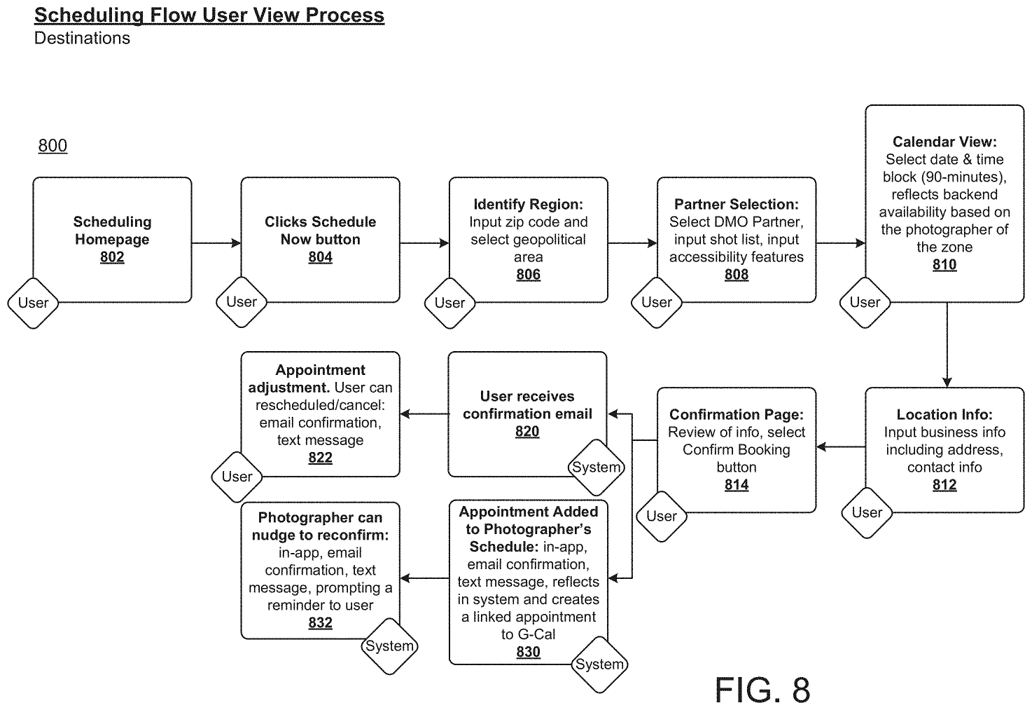

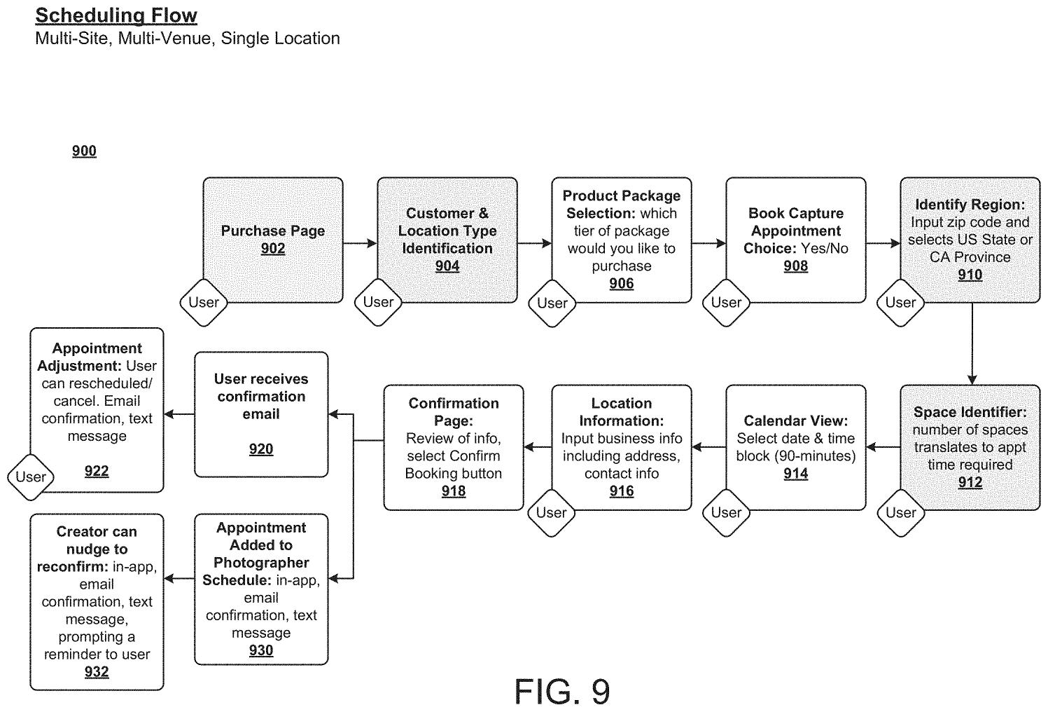

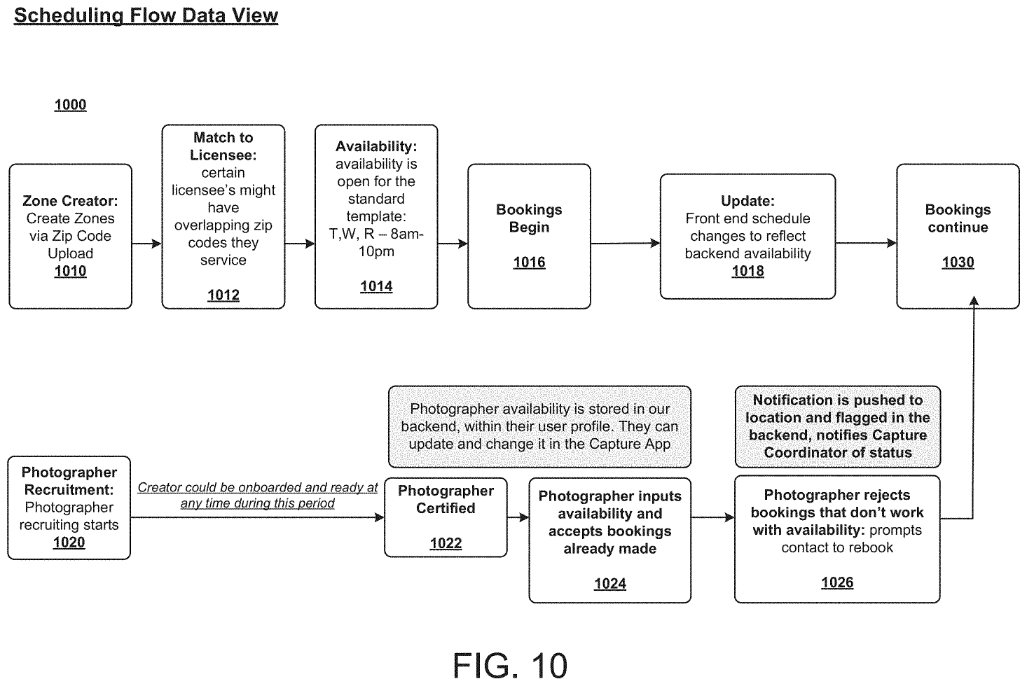

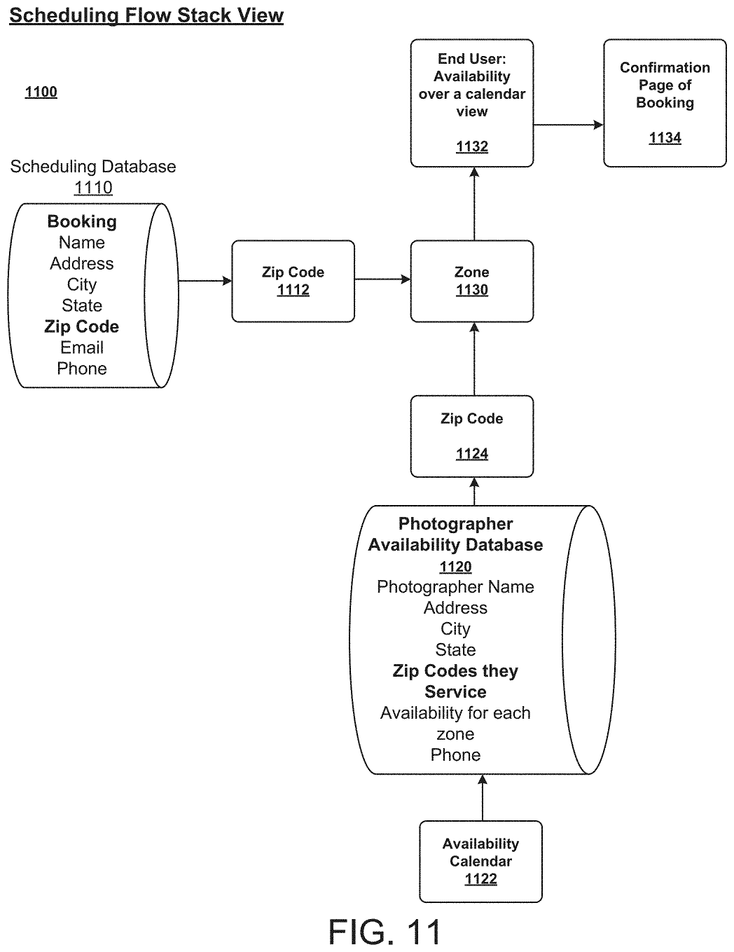

In some cases, the data processing system 102 can identify multiple entry points in the image data, and then provide a prompt to select one entry point from the multiple entry points for which to generate the step-in transition. The data processing system 102 can provide, responsive to selection of the door of the one or more doors, the set of sprites to form an outline for the door. The data processing system 102 can generate the step-in animation for the step-in transition based on the set of sprites. The data processing system 102 can integrate the step-in animation with the virtual tour. To do so, in some cases, the data processing system 102 can overlay an icon (e.g., the step in transition 128 depicted in FIG. 2I) on the image data to generate the step-in animation.

The data processing system 102 can include a camera bearing controller 110 designed, constructed and operational to establish a camera pose or bearing to facilitate panoramic connection. The camera bearing controller 110 can determine the camera bearing or pose given a current registration as indicated by another image. The camera bearing controller 110 can be configured with a pose extraction technique that can compare two subsequent images to identify the camera position for the first image based on the subsequent image. The camera bearing controller 110 can be configured with a panoramic image function that can process spherical or epipolar geometry of the images.

The data processing system 102 can include characteristic generator 108 designed, constructed and operational to automatically generate characteristics for the connected set of images and for inclusion in the virtual tour. The characteristic generator 108 can use the features detected by the image feature detector 104 to generate a virtual tour with an animation that steps through the sequence of images to provide a linear direction. The data processing system 102 can store the generator virtual tour in virtual tour database 134. The virtual tour stored in the database 122 can be referred to as virtual tour 134. The characteristic generator 108 can initialize the virtual tour with an automated camera pan at one or more sides. The characteristic generator 108 can identify a direction of the camera path and generate chevrons or other icons to embed of overlay on the camera path in the virtual tour that correspond to the direction. The characteristic generator 108 can provide for interactivity with the virtual tour, such as the ability for the user to pause the virtual tour, go forwards or backwards, pan left or right, lean-back or lean forward. The characteristics can include sprites for the door frame outline, for example.

The data processing system 102 can include an authoring tool designed, constructed and operational to allow for interactive authoring, persisting, or replaying a camera position for each panoramic image. A user can interface with the authoring tool 114 via a graphical user interface. The data processing system 102, or authoring tool 114, can provide a graphical user interface accessible by the client device 140, for example. Using the graphical user interface, a user (or content provider, or administrator) can tag hot spots in a room corresponding to the images. The user can author a separate path based on a panoramic path, create or input metadata for the panoramic path, or establish default turns. The user can provide or integrate logos into the images for presentation with the virtual tour. The logo can be integrated within the visible viewer context.

The data processing system 102 can include a viewer delivery controller 112 designed, constructed and operational to provide a virtual tour for rendering via viewer application 144 on a client device 140. The viewer delivery controller 112 can receive a request from a client device 140 for a viewer application or virtual tour. For example, a client application 142 (e.g., a web browser) executing on the client device 140 can make a call or request to the data processing system 102 for a viewer. The call can be made via JavaScript or iFrame to the data processing system 102. The viewer delivery controller 112 can receive the JavaScript or iFrame call or request. The viewer delivery controller 112 can provide the viewer application 144 to the client device 140. The viewer delivery controller 112 can provide the viewer application 144 responsive to the request or call received from the client device 140 via the network 101.

The viewer delivery controller 112 can provide the virtual tour 134 to the viewer application 144 for playback on the client application 142 or client device 140. The virtual tour 134 can include or be based on the internal image data 124 or metadata 126. The viewer application 144 executing on the client device 140 can download the virtual tour 134 or other panoramic image data for playback or rendering on the client device 140.

Still referring to FIG. 1, and in further detail, the data processing system 102 can include a step in correlator 116 designed, constructed and operational to sync and compare the set of key data from the image iterator 106 from the third party data, which can include image data 152 and geoposition data 154, and internal image data 124. The step in correlator 116 can also directly sync and compare the image data 152 and geoposition data 154 from the third party database 150 to the internal image data 124. The step in correlator 116 can use machine learning to sync and compare the data, which consistently refines and improves the image correlation. For example, the data processing system 102 can use machine learning to make use of saved data, such as internal image data 124, to match to images of doors from third party databases, discussed more below. Over time, the machine learning program can do so more reliably because it leverages the matches it already identified. Thus, during the machine learning process there is an increase in internal image data 124 that can be used to compare to image data 152 and geoposition data 154 from the third party database 150, which results in an improvement of image correlation as there is more internal images to correlate.

The image data 152 and geoposition data 154 from the third party database 150 can be captured from a client device 140, which is in communication with the third party database 150 via network 101. The step in correlator 116 can be configured with various synchronization techniques, including, for example, process synchronization, such as lock, mutex, or semaphores, or data synchronization, such as maintaining the data to keep multiple copies of data coherent with each other, or to maintain data integrity. The step in correlator 116 can be configured with various comparison techniques, including, for example, machine learning, comparison algorithms such as server-side data comparison using the resources of the server, local data comparison with comparison results stored in RAM, or local data comparison with comparison results stored as a cached file on the disk. The step in correlator 116 can be configured with various comparison techniques, including, for example, comparison tools such as dbForge Data Compare for SQL Server, dbForge Data Compare for MySQL, dbForge Data Compare for Oracle, or dbForge Data Compare for PostgreSQL.

For example, the step in correlator 116 can identify, in a data repository 122, a virtual tour 134 of an internal portion of a physical building formed from multiple images (e.g., internal image data 124) connected with a linear path along a persistent position of a virtual camera. The step in correlator 116 can receive, from a third-party data repository or database 150, image data 152 or geoposition data 154 corresponding to an external portion of the physical building in the virtual tour 134. In some cases, the data processing system 102 can determine a location of the physical building of the virtual tour 134. The data processing system 102 can query the third-party data repository 150 with the location. The data processing system 102 can receive, from the third-party data repository 150, the image data 152 responsive to the query.

The step in correlator 116 can compare the image data 152 from the third party database 150 and internal image data 124 (e.g., the internal image data 124 used to form the virtual tour 134). In an illustrative example, the third party database 150 can be third party maps and the image data 152 can include an image of a door captured from the client device 140, which can be used to generate the virtual tour 134. The door can be an entrance to a school, hotel, office, venue, or other commercial structure. The step in correlator 116 can compare the image of the door, categorized as image data 152, to images of doors saved on the database 122 as internal image data 124. In another example, the step in correlator 116 can compare features detected from the image feature detector 104, such as door knobs to internal image data 124.

The step in correlator 116 can compare the geoposition data 154 from the third party database 150 to the internal image data 124. In an illustrative example, the third party database 150 can be third party maps and the geoposition data 154 can include a zip code, an address, and/or a latitude and longitude captured from the client device 140. For example, the geoposition data 154 can be an address to a restaurant. The step in correlator 116 can access the website of the restaurant leveraging the address, categorized as geoposition data 154, captured by the client device 140 and compare the images on the website to images saved on the database 122 as internal image data 124.

The step in correlator 116 can compare both the image data 152 and the geoposition data 154 from the third party database 150 to the internal image data 124. In an illustrative example, the third party database 150 can be third party maps, the geoposition data 154 can include a zip code, an address, and/or a latitude and longitude captured from the client device 140, and the image data 152 can include an image of a door captured from the client device 140. For example, the geoposition data 154 can be a zip code, such as 02116, and the image data 152 can be a particular arched door. There can be numerous of the particular arched doors, categorized as image data 152, in third party maps, categorized as the third party database 150. However, there may be only one of the particular arched doors in the zip code 02116, categorized as geoposition data 154. The arched door can be compared to the internal image data 124. Or, there may be numerous of the particular arched doors in the zip code 02116, categorized as geoposition data 154. The data processing system 102 can identify if a number of the particular arched doors belong to residences leveraging geoposition data 154, such as addresses. If a particular arched door belongs to a residence, it will not be compared to the internal image data 124.

The data processing system 102 can include a step in detector 118 designed, constructed and operational to identify an entrance from the image data 152 and geoposition data 154 of the third party database 150. The step in detector 118 can be configured to identify an entrance by leveraging the results from the step in correlator 116. The step in detector 118 can detect, within the image data 152, an entry point (e.g., an entry point 202 depicted in FIGS. 2A-2J) for the internal portion of the physical building. The step in detector 118 can identify if the image data 152 and/or geoposition data 154 match the internal image data 124 based off of the comparison results produced by the step in correlator 116. A threshold confidence match can be established. The step in detector 118 can use machine learning to detect an entrance or identify a door. As discussed above, the step in correlator 116 can use machine learning to sync and compare the data, which consistently refines and improves the image correlation. The step in detector 118 can use machine learning to make use of saved data, such as internal image data 124, to match to images of doors from third party databases. Over time, the machine learning program can match images of doors from third party databases with images of doors from internal databases more reliably because it leverages the matches it already identified. The step in detector 118 can be configured with various detection techniques, including, for example, one or more of SIFT, SURF, AKAZE, and BRISK. The step in detector 118 can use a combination of octave and octave layers, scale factors, sigma values, and feature limiters to extract the target data sets.

The step in detector 118 can perform image processing on the images to identify entrances. For example, the step in detector 118 can detect doors and archways. The data processing system 102 can cast rays to corner points of the door and determine which faces are identified or hit. Since door images can be spread on up to four different cube faces, for example, the data processing system 102 casts the rays to the corner points to identify which faces are hit. The data processing system 102 can then dynamically create an alpha mask in a canvas based on those coordinates. The data processing system 102 can apply this alpha mask to the texture of the cube faces. In some cases, the data processing system 102 can initiate binary searching along the distance between dots, and draw lines to the edge of the face for as many faces involved as necessary. Thus, the data processing system 102 can cast rays to corner points of one or more doors in the image data to identify a cube face of a plurality of cube faces. The data processing system 102 can assign the entry point to a door of the one or more doors corresponding to the identified cube face of the plurality of cube faces.

The data processing system 102 can include a step in transition generator 120 designed, constructed and operational to automatically generate a step in transition 128 through the entrance. The step in transition generator 120 can generate, responsive to the detection of the entry point, a step-in transition at the entry point in the image data. The data processing system 102 can create an external spatial map of data captured by a client device 140 and align it with geoposition data 154 of the third party database 150 to provide a seamless step in transition 128 from the external third party database 150 to the internal database 122. The step in transition 128 can be integrated into the virtual tour. The step in transition generator 120 can provide animations for the outline of the door. The step in transition generator 120 can provide a set of sprites, such as a computer graphic that can be moved on-screen or otherwise manipulated as a single entity. The step in transition generator 120 can provide the set of sprites around the door outline to form the frame of the door. The step in transition generator 120 can scale the animation logic in size or opacity.

The step in transition 128 automatically generated by the step in transition generator 120 can include various effects, for example, crossfade, zoom in, radial fade, fly in, vertical wipe, clock wipe, dot effect, or blink in. The step in transition generator 120 can determine the effect depending on the geoposition data 154 from the third party database 150. For example, if the geoposition data 154 includes an address associated with a hotel, then the step in transition generator 120 can use a cohesive set of rules to generate one of the various effects. Further, in another example, if the geoposition data 154 includes an address associated with a mall, then the step in transition generator 120 can use a cohesive set of rules to generate one of the various effects, which can be the same as or different from the effect generated for a hotel.

The step in transition generator 120 can use the entrance or entrances detected by the step in detector 118 to generate a step in transition with an animation that steps through the entrance. The data processing system 102 can store the generated step in transition in the step in transition database 128. The step in transition stored in the database 122 can be referred to as step in transition 128. The step in transition generator 120 can initialize the step in transition 128 with an automated camera pan at one or more sides. The step in transition generator 120 can provide for interactivity with the virtual tour, such as the ability to generate an interactive icon which can be engaged with by the user to initiate the step in transition 128. The step in transition 128 can include sprites for the door frame outline, for example. The step in transition generator 120 can provide the generated step in transition 128 to the characteristic generator 108 to integrate the step in transition 128 into the virtual tour.

If the step in detector 118 did not identify an entrance because no threshold confidence match was established, the step in transition generator 120 can create an entrance and generate a step in transition with an animation that steps through the entrance. The step in transition generator 120 can fully automate door or entrance creation and generate a step in transition with an animation that steps through the entrance using machine-learning. The data processing system 102 can store the generated step in transition in the step in transition database 128. The step in transition generator 120 can initialize the step in transition 128 with an automated camera pan at one or more sides. The step in transition generator 120 can provide for interactivity with the virtual tour, such as the ability to generate an interactive icon which can be engaged with by the user to initiate the step in transition 128. The step in transition 128 can include sprites for the door frame outline, for example. The step in transition generator 120 can provide the generated step in transition 128 to the characteristic generator 108 to integrate the step in transition 128 into the virtual tour.

If the step in detector 118 identified numerous entrances or doors, the data processing system 102 can provide a prompt to the end user. In an illustrative example, if the step in detector 118 identified three doors having the threshold confidence match, based off of similar image data 152 and geoposition data 154, then the data processing system 102 can provide a prompt to the client device 140, and thus the end user, via network 101. The prompt can request the user to select the desired door and upon selection the step in transition generator 120 can create an entrance and generate a step in transition 128. Thus, and in some cases, the data processing system 102 can identify a plurality of entry points in the image data. The data processing system 102 can provide a prompt to a second client device (e.g., a client device corresponding to an administrator of the virtual tour that is different from a user that is viewing the virtual tour) to select one entry point from the plurality of entry points for which to generate the step-in transition.

If the step in detector 118 identified numerous entrances or doors, the data processing system can generate an error code and stop the step in transition generator 120 from generating a step in transition 128. In an illustrative example, if the step in detector 118 identified two neighboring buildings having the threshold confidence match, based off of similar image data 152 and geoposition data 154, then the data processing system 102 can generate an error that inhibits the step in transition generator 120 from generating a step in transition 128.

The data processing system 102 can connect the virtual tour 134 with the step-in transition 128 generated for the image data 152 at the entry point (e.g., entry point 202). Connecting the virtual tour 134 with the step-in transition 128 can refer to or include establishing an association, link, pointer, mapping, or other reference between the step in transition 128 and the virtual tour 134. The connection between the virtual tour 134 and the step in transition 128 can cause invocation of the virtual tour 134 responsive to an interaction with the step in transition 128. For example, a client device 140 can interact with the step in transition 128, which can create a request for the corresponding virtual tour 134 or otherwise initiate playback of the virtual tour 134 that is associated or linked with the step in transition 128. The data processing system 102 can receive a request for the virtual tour responsive to an interaction with the step in transition 128, and then stream the virtual tour to the client device 140 (e.g., for rendering in the viewer application 144). The data processing system 102 can perform a lookup in database 122 to identify the virtual tour 134 that corresponds to the step in transition 128.

The system 100 can include, interface with or otherwise communicate with a client device 140. The client device 140 can include one or more component or functionality depicted in FIG. 3. The client device 140 can execute, host, or run a client application 142. The client application 142 can include a native browser, web browser, or other application capable of or configured to access a website, domain, or other resource hosted or provided by a server, such as data processing system 102. The client application 142 can include or be configured to process one or more network protocols in one or more programming languages. For example, the client application 142 can parse or process hypertext markup language (HTML), javascript, or other scripts.

The client application 142 can navigate to or access a reference, address, or uniform resource locator. The client application 142 can render HTML associated with the URL. The client application 142 can trigger a call associated with the URL. For example, the viewer application 144, upon a page refresh, can make a call via javascript or iFrame to the data processing system 102. Responsive to the call, the client application 142 can download the viewer application 144. The data processing system 102 (e.g., via the viewer delivery controller 112) can provide the viewer application 144 to the client application 142.

The viewer application 144 can be presented or provided within the client application 142. The viewer application 144 can be presented on the client device 140 within an iFrame or portion of the client application 142. In some cases, the viewer application 144 can be presented in a separate window or pop-up on the client device 140. In some cases, the viewer application 144 can open as a separate, native application executing on the client device 140 that is separate from the client application 142.

The client device 140 can launch, invoke, or otherwise present the viewer application 144 responsive to downloading the viewer application from the data processing system 102. The client device 140, or viewer application 144, can download the content stream including metadata for the content stream. For example, the viewer application 144 can download the step in transition 128 and the virtual tour 134 from the data processing system 102. The viewer delivery controller 112 can provide the step in transition 128 and the virtual tour 134 to the viewer application 144. The viewer delivery controller 112 can select the step in transition 128 and the virtual tour 134 associated with the reference, URL, or other address input into the viewer application 144 or the client application 142. For example, when a user navigates to a resource via the client application 142, the client application 142 can make a call for the viewer application 144. The call for the viewer application 144 can include an identifier of the step in transition 128 and/or the virtual tour 134 that has been established or pre-selected for the resource. In some cases, the viewer application 144 can present an indication of the step in transition 128 and/or the virtual tours 134 that are available for the website, and receive a selection of the virtual tour from the user.

The viewer application 144 can present a control interface 146 designed, constructed and operational to provide user interface elements. The control interface 146 can provide buttons, widgets, or other user interface elements or other interactive icons. The control interface 146 can receive input from a user of the client device 140. The control interface 146 can provide the ability to control playback of the virtual tour. The control interface 146 can provide a playback button or other buttons that can control one or more aspects of the virtual tour.

In some cases, the control interface 146 can receive mouse down interactivity outside the frame of the client application 142 in which the viewer application 144 is presenting the virtual tour. For example, the control interface 146 can provide continuing user control of camera position in the virtual tour when moving the mouse outside the viewer application 144 showing the virtual tour.

To facilitate a smooth, seamless playback of the virtual tour, the viewer application 144 can include a cache prioritizer 148 designed, configured and operational to automatically download elements of the virtual tour. The cache prioritizer 148 can be configured with a function or algorithm for progressive caching. Using the function, the cache prioritizer 148 can automatically download higher priority elements first or ahead of lower priority elements in the virtual tour. For example, higher priority elements can include immediately-visible images, followed by 2^{nd}-tier (or lower priority) content, such as subsequent images or other characteristics.

The cache prioritizer 148 can be configured to select a prioritization function or algorithm based on the type of virtual tour, type of client device 140, available bandwidth associated with network 101, size of the images or virtual tour, speed of the playback, a subscription plan associated with the provider of the virtual tour, or other attributes. In some cases, the cache prioritizer 148 can adjust the priority of elements based on historical feedback or performance attributes.

FIGS. 2A-2H depict illustrations of various commercial venue entryways on third party databases, in accordance with implementations. The illustrations can be categorized as image data 152 and the third party database can be categorized as third party database 150 depicted in FIG. 1. The image data 152 can be captured via a client device 140 depicted in FIG. 1. The image data 152 can be stored as metadata 126 in database 122 depicted in FIG. 1. The image data 152 can be compared to internal image data 124 in database 122 via step in correlator 116 depicted in FIG. 1.

For example, the illustrations in FIGS. 2A-2H can have limited features or functions to improve efficiency of delivery, while increasing engagement and improving user experience. The data processing system 102 can create an external spatial map of image data 152 captured by a client device 140 and align it with geoposition data 154 of the third party database 150 to provide a seamless step in transition 128 from the external third party database 150 to the internal database 122. The illustrations in FIGS. 2A-2H can include a rendering based on geoposition data 154 and image data 152. The illustration sin FIGS. 2A-2H can include an entry point 202. The entry point 202 can be detected by the data processing system 102 (e.g., via the step in detector 118).

FIG. 2A depicts an illustration of a hotel with an entryway and numerous windows. The illustration of the hotel can be categorized as image data 152. The illustration includes a map, which can be categorized as geoposition data 154. The image data 152 and the geoposition data 154 can be compared to internal image data 124 in database 122 via step in correlator 116 depicted in FIG. 1. The step in detector 118 depicted in FIG. 1 can establish if there is a threshold confidence match between the third party data (the image data 152 and the geoposition data 154) and the internal image data 124. Since there are numerous windows, the step in detector 118 may detect multiple doors. If the step in detector 118 identifies multiple doors, the data processing system 102 can provide a prompt to the client device 140, and thus the end user, via network 101, as depicted in FIG. 1. The prompt can request the user to select the desired door and upon selection the step in transition generator 120 can create an entrance and generate a step in transition 128 as depicted in FIG. 1.

FIG. 2B depicts an illustration of a restaurant, which can be categorized as image data 152, from a third party database 150. The illustration includes a map, which can be categorized as geoposition data 154. The third party database 150 includes interactive icons, such as a chevron arrow, to signal to an end user to virtually enter the restaurant door. The image data 152 and the geoposition data 154 can be compared to internal image data 124 in database 122 via step in correlator 116 depicted in FIG. 1. The step in detector 118 depicted in FIG. 1 can establish if there is a threshold confidence match between the third party data (the image data 152 and the geoposition data 154) and the internal image data 124 and if so, detect the door. Once the restaurant door is detected, the step in transition generator 120 can generate a step in transition 128 whereby the user can virtually and seamlessly step into the restaurant, as depicted in FIG. 1.

FIG. 2C depicts an illustration of a college university, which can be categorized as image data 152, from a third party database 150. The college university has three arched doorways. The illustration includes a map, which can be categorized as geoposition data 154. The image data 152 and the geoposition data 154 can be compared to internal image data 124 in database 122 via step in correlator 116 depicted in FIG. 1. The step in detector 118 depicted in FIG. 1 can establish if there is a threshold confidence match between the third party data (the image data 152 and the geoposition data 154) and the internal image data 124. Since there are numerous windows, the step in detector 118 may detect multiple doors. If the step in detector 118 identifies multiple doors, the data processing system 102 can generate an error code and stop the step in transition generator 120 from generating a step in transition 128, as depicted in FIG. 1.

FIG. 2D depicts an illustration of a public library, which can be categorized as image data 152, from a third party database 150. The doorway is surrounded by windows. The illustration includes a map, which can be categorized as geoposition data 154. The image data 152 and the geoposition data 154 can be compared to internal image data 124 in database 122 via step in correlator 116 depicted in FIG. 1. The step in detector 118 depicted in FIG. 1 can establish if there is a threshold confidence match between the third party data (the image data 152 and the geoposition data 154) and the internal image data 124 and if so, detect the door. Once the door is detected, the step in transition generator 120 can generate a step in transition 128 whereby the user can virtually and seamlessly step into the public library, as depicted in FIG. 1.

FIG. 2E depicts an illustration of a baseball stadium, which can be categorized as image data 152, from a third party database 150. The entryway is a large archway with two columns. The illustration includes a map, which can be categorized as geoposition data 154. The image data 152 and the geoposition data 154 can be compared to internal image data 124 in database 122 via step in correlator 116 depicted in FIG. 1. The step in detector 118 depicted in FIG. 1 can establish if there is a threshold confidence match between the third party data (the image data 152 and the geoposition data 154) and the internal image data 124. If the step in detector 118 did not identify an entrance because no threshold confidence match was established, the step in transition generator 120 can create an entrance and generate a step in transition 128 with an animation that steps through the entrance, as depicted in FIG. 1.

FIG. 2F depicts an illustration of an elementary school, which can be categorized as image data 152, from a third party database 150. The door is at the top of stairs. The illustration does not provide geoposition data 154, so the step in correlator 116 depicted in FIG. 1 can compare only the image data 152 and the internal image data 124 in database 122. The step in detector 118 depicted in FIG. 1 can establish if there is a threshold confidence match between the image data 152 and the internal image data 124 and if so, detect the door. Once the door is detected, the step in transition generator 120 can generate a step in transition 128 whereby the user can virtually and seamlessly step into the school, as depicted in FIG. 1.

FIG. 2G depicts an illustration of an elementary school, which can be categorized as image data 152, from a third party database 150. The illustration includes a map, which can be categorized as geoposition data 154. The entryway is an opening between two columns. Since the view angled and no door is detectable, there may be no image data 152 available. So, the step in correlator 116 depicted in FIG. 1 can compare only the geoposition data 154 and the internal image data 124 in database 122. The step in detector 118 depicted in FIG. 1 can establish if there is a threshold confidence match between the geoposition data 154 and the internal image data 124 and if so, detect an entryway. Once the entryway is detected, the step in transition generator 120 can generate a step in transition 128 whereby the user can virtually and seamlessly step into the school, as depicted in FIG. 1.

FIG. 2H depicts an illustration of a baseball stadium, which can be categorized as image data 152, from a third party database 150. There are multiple garage doors as entryways. The illustration includes a map, which can be categorized as geoposition data 154. The image data 152 and the geoposition data 154 can be compared to internal image data 124 in database 122 via step in correlator 116 depicted in FIG. 1. The step in detector 118 depicted in FIG. 1 can establish if there is a threshold confidence match between the third party data (the image data 152 and the geoposition data 154) and the internal image data 124. Since there are two entryways, the step in detector 118 may detect multiple doors. If the step in detector 118 identifies multiple doors, the data processing system 102 can provide a prompt to the client device 140, and thus the end user, via network 101, as depicted in FIG. 1. The prompt can request the user to select the desired door and upon selection the step in transition generator 120 can create an entrance and generate a step in transition 128 as depicted in FIG. 1.

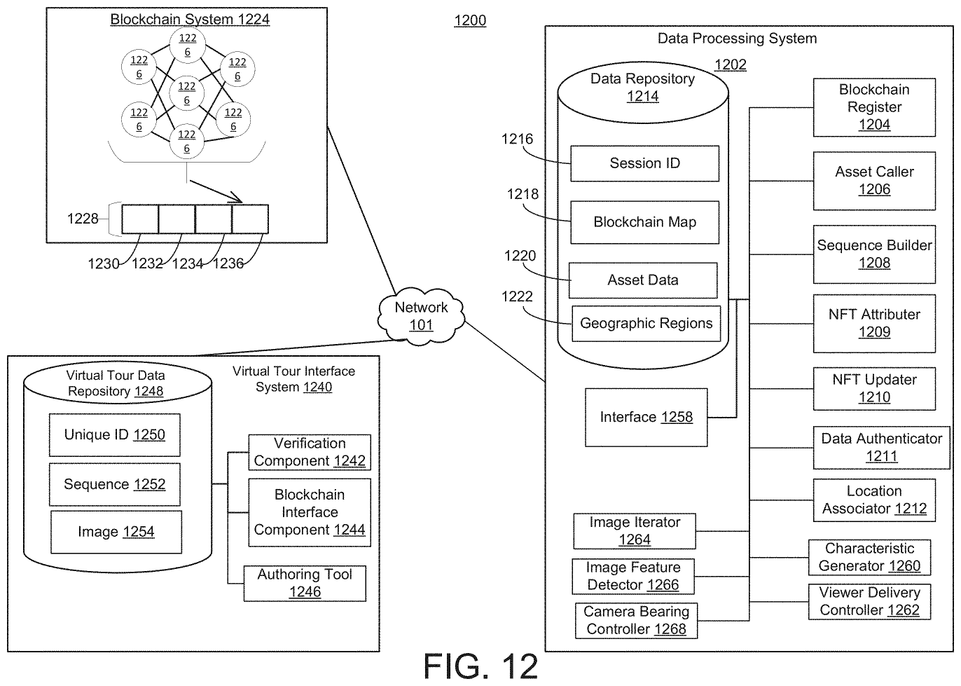

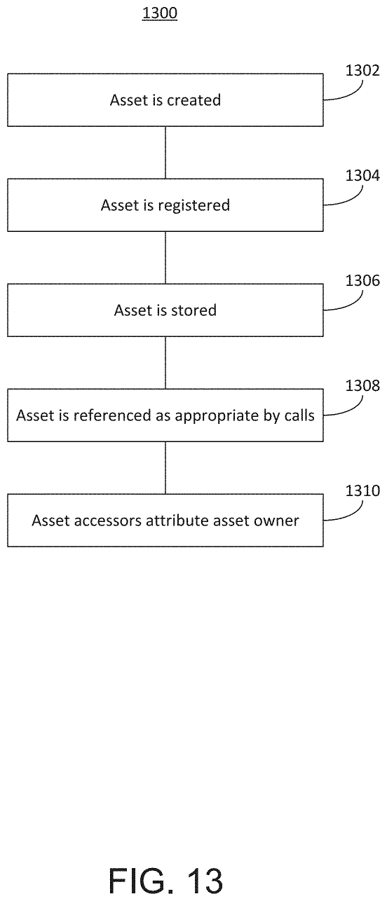

FIGS. 21 and 2J depict illustrations of the interactive icon generated to facilitate the step in transition, in accordance with implementations. The step in transition can be generated by the step in transition generator 120 of the data processing system 102 depicted in FIG. 1. The step in transitions can include automatically generated characteristics, such as interactive features like an illuminated door frame or an illuminated door frame with a user command such as “STEP INSIDE.” The data processing system can allow a user to click on the interactive feature and virtually step into the structure. FIGS. 2I-2J depict a step in transition 128. The data processing system 102 (e.g., via step in transition generator 120) can generate the step in transition 128.

For example, the step in transition 128 as shown in FIGS. 21 and 2J can have limited features or functions to improve efficiency of delivery, while increasing engagement and improving user experience. The user can control the experience by controlling the step in transition 128 and subsequently the virtual tour (e.g., virtual tour 134 depicted in FIG. 4) that the step in transition 128 is integrated into. The virtual tour 134 can include an interactivity feature generated by the data processing system 102 that can allow a user to click and drag to look around the image.

FIG. 3 is a block diagram of an example computer system 300 that can be used to implement or perform one or more functionality or element of this technical solution. The computer system or computing device 300 can include or be used to implement the data processing system 102, or its components such as the data processing system 102. The computing system 300 includes at least one bus 305 or other communication component for communicating information and at least one processor 310 or processing circuit coupled to the bus 305 for processing information. The computing system 100 can also include one or more processors 310 or processing circuits coupled to the bus for processing information. The computing system 100 also includes at least one main memory 315, such as a random access memory (RAM) or other dynamic storage device, coupled to the bus 305 for storing information, and instructions to be executed by the processor 310. The main memory 315 can be or include the memory 122. The main memory 315 can also be used for storing virtual machine information, hardware configuration information of the virtual machine, software configuration information of the virtual machine, IP addresses associated with the virtual machine or other information during execution of instructions by the processor 310. The computing system 100 may further include at least one read only memory (ROM) 320 or other static storage device coupled to the bus 305 for storing static information and instructions for the processor 310. A storage device 325, such as a solid state device, magnetic disk or optical disk, can be coupled to the bus 305 to persistently store information and instructions. The storage device 325 can include or be part of the memory 122.

The computing system 100 may be coupled via the bus 305 to a display 335, such as a liquid crystal display, or active matrix display, for displaying information to a user. An input device 330, such as a keyboard or voice interface may be coupled to the bus 305 for communicating information and commands to the processor 310. The input device 330 can include a touch screen display 335. The input device 330 can also include a cursor control, such as a mouse, a trackball, or cursor direction keys, for communicating direction information and command selections to the processor 310 and for controlling cursor movement on the display 335. The display 335 can be part of the data processing system 102, or other component of FIG. 1.

The processes, systems and methods described herein can be implemented by the computing system 100 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 100 to perform the illustrative processes described herein. One or more processors in a multi-processing arrangement may also be employed to execute the instructions contained in main memory 315. Hard-wired circuitry can be used in place of or in combination with software instructions together with the systems and methods described herein. Systems and methods described herein are not limited to any specific combination of hardware circuitry and software.

Although an example computing system has been described in FIG. 3, the subject matter including the operations described in this specification can be implemented in other types of digital electronic circuitry, or in computer software, firmware, or hardware, including the structures disclosed in this specification and their structural equivalents, or in combinations of one or more of them.

FIG. 4 depicts an illustration of a predetermined virtual tour 134, in accordance with an implementation. The virtual tour 134 can be generated by the data processing system 102 depicted in FIG. 1. The virtual tour 134 can include automatically generated characteristics, such as chevrons, icons and interactive features. The data processing system 102 can generate the virtual tour 134 to allow a user to click and drag to look around or pan around the virtual tour. The data processing system 102 can generate the virtual tour 134 to include chevrons or strike points that provide a predetermined path.

For example, virtual tour 134 as shown in FIG. 4 can have limited features or functions to improve efficiency of delivery, while increasing engagement and improving user experience. The user can control the experience by controlling the virtual tour 134. The virtual tour 134 can include an interactivity feature generated by the data processing system 102 that can allow a user to click and drag to look around the image. The data processing system 102 can generate chevrons or icons for the virtual tour that indicate a direction of the camera path.

The data processing system 102 can provide or stream the virtual tour 134 to the client device 140 for rendering. The data processing system 102 can deliver the viewer application 144 for execution in a client application 142 on the client device 140. The data processing system 102 can deliver the viewer application 144 responsive to an interaction with an entry point by the client device 140, such as an entry point 202 depicted FIGS. 2A-2J. The data processing system 102 can stream, to the viewer application 144, the virtual tour 134 to cause the viewer application 144 to automatically initiate playback of the virtual tour 134 upon receipt of the streamed virtual tour.

FIG. 5 depicts an example method 500 for connecting external data and internal image data to generate a step in transition which can be integrated into a virtual tour. The method 500 can be performed by one or more system or component depicted in FIG. 1 or FIG. 3, including, for example, a data processing system. The method 500 can utilize, provide, generate, or otherwise interface with one or more graphical user interface depicted in FIGS. 2A-2J or FIG. 4. In brief overview, at ACT 502, the data processing system can identify a virtual tour. At ACT 504, the data processing system can receive image data. At ACT 506, the data processing system can detect an entry point. At ACT 508, the data processing system can generate a step in transition. At ACT 510, the data processing system can connect the virtual tour with the step in transition. At ACT 512, the data processing system can initiate a step in transition to stream the virtual tour.

Still referring to FIG. 5, and in further detail, the data processing system can identify a virtual tour at ACT 502. The data processing system can identify a virtual tour of an internal portion of a physical building. The virtual tour can be formed from images connected with a linear path along a persistent position of a virtual camera. The data processing system can identify the virtual tour responsive to a request from an administrator of the virtual tour to generate a step in transition for an image.

In some cases, the data processing system can identify the virtual tour responsive to a request from an administrator of a third party database that manages the third-party image data. For example, the administrator of the third-party database may be send a request to connect exterior image data with internal virtual tours. The data processing system, responsive to such a request, can perform a lookup in the database to identify a virtual tour that corresponds to a location of the image data.

In another example, the data processing system can identify virtual tours in an internal database for which external step in transitions have not yet been connected. The data processing system can query a third party data repository with a location of the virtual tour in order to obtain the external image data.

At ACT 504, the data processing system can receive image data. The data processing system can receive the image data from a third-party database. The image data can include or correspond to an external portion of a physical building. The physical building can be the same physical building for which the virtual tour was generated.

At ACT 506, the data processing system can detect an entry point. The data processing system can detect the entry point for an internal portion of the physical building. The entry point can correspond to a beginning or initial point of the virtual tour. The entry point on the external portion of the physical building can correspond to the same beginning point as the virtual tour. For example, a first image or frame of the virtual tour can be used to perform a comparison with the third-party image data in order to detect a matching portion, which can be used as the entry point. The entry point can correspond to a door or type of door used to enter the physical building.

At ACT 508, the data processing system can generate a step in transition. The data processing system can generate the step in transition responsive to detection of the entry point. the data processing system can generate any type of step in transition, which can include an animation or icon. The step in transition can include an animation going from the external to the internal of the physical building.

At ACT 510, the data processing system can connect the virtual tour with the step in transition. Connecting the virtual tour can refer to or include associating the entry point and step in transition with the corresponding virtual tour. In some cases, the data processing system can connect the virtual tour with the step in transition by integrating or adding the step in transition or animation to the virtual tour itself. For example, the data processing system can update the virtual tour stored in the data repository of the data processing system to include the step in transition generated by the data processing system for the entry point detected in the third party image data.

At ACT 512, the data processing system can initiate a step in transition to stream the virtual tour. The data processing system can receive a request from a user based on an interaction with the step in transition. Interacting with the step in transition can cause the data processing system to identify the corresponding virtual tour, and provide the virtual tour for streaming or rendering on the client device.

An aspect of this technical solution can be generally directed to connecting customer provided locations and capture participants, e.g., photographers, to provide the on-demand capture of location attributes. This technical solution can facilitate self-scheduling, which provides multiple customers, who may provide multiple locations, to access a web page and each choose an available time for a regional resource, e.g., photographer, to come and perform location attribute capture. Both the customer and the photographer have the ability to reschedule or cancel the scheduled capture. The customer can provide preparatory materials, such as shots lists, example content, and to-dos, to the photographer before the scheduled capture. The process therefore provides a scheduling platform that customers can use to help increase overall efficiency and maximize the likelihood that all target locations will be captured within a limited timeframe. The process also provides an availability input platform that photographers can use to increase overall scheduling efficiency.

FIG. 6 depicts a block diagram of an illustrative system for connecting customer provided locations and capture participants, e.g., photographers, to provide the on-demand capture of location attributes, in accordance with an implementation. The system 600 can include a data processing system 602 designed, constructed and operational to allow a user to book an on-demand location attribute capture by receiving and storing user input location data (e.g., zip codes), defining the location data as specific zones, and assigning photographers to service certain zones. The data processing system 602 can include one or more processors, servers, or other hardware components depicted in FIG. 12. The system 600 can include a customer dashboard 654 designed constructed and operational to serve as a platform for the user to input information and receive information. The system 600 can include a capture application 674 designed constructed and operational to serve as a platform for the photographer to input information and receive information. The system 600 can include a backend 680 designed constructed and operational to store photographer availability information, schedule bookings, flag cancellations, and track the status of bookings. The data processing system 602, the customer dashboard 654, the capture application 674, and the backend 680 are all in communication via network 101.

Still referring to FIG. 6, and in further detail, the data processing system 602 can include a zone zip code correlator 604. The data processing system 602 can include a geopolitical area recognizer 606. The data processing system 602 can include a photographer zone assigner 608. The data processing system 602 can include a customer dashboard delivery controller 610. The data processing system 602 can include a confirmation generator 612. The data processing system 602 can include an updater 614. The data processing system 602 can include a scheduling database 616, which can include a location zip codes 618, a location area identifier 620, a location zones 622, a contact information 624, a user inputs 626, an appointments 628, and a location capture time requirement 630. The data processing system 602 can include a photographer availability database 632, which can include a photographer zones 634, a photographer availability 636, a photographer schedule 638, and a contact information 640. The data processing system 602 can include a database 642, which can include an all zip codes 644 and an assigned zones 646.

Referring to FIG. 6 in more detail, the zone zip code correlator 604 can access the zip codes stored in all zip codes 644 in the database 642. For example, zip codes can be uploaded and stored in all zip codes 644 of the database 642 of the data processing system 602. The zip codes can be uploaded via the customer dashboard 654, the capture application 674, and/or the backend 680. The zone zip code correlator 604 of the data processing system 602 can create zones using the zip codes uploaded and stored in the database 642. For example, the zone zip code correlator 604 can define a specific zip code, such as 02616, as a specific zone, such as Zone 1. The data processing system 602 can store the corresponding zones created in the assigned zones 646 in the database 642 of the data processing system 602, described in more detail below.

Continuing to refer to FIG. 6 in more detail, a user can input a zip code, which the zone zip code correlator 604 of the data processing system 602 of FIG. 6 correlates with a zone. For example, the user can input a zip code via the control interface 656 of the customer dashboard 654. The data processing system 602 can recognize a pattern, for example, a 5-digit number represents a zip code. The recognized zip code input by the user is stored in the location zip codes 618 of the scheduling database 616. The zone zip code correlator 604 of the data processing system 602 compares the zip code input by the user and the zip codes stored in all zip codes 644 of the database 642 and finds a match. If there is no match, a new zone is created and stored in assigned zones 646 of database 642. Once there is a zip code match, the zone zip code correlator 604 of the data processing system 602 uses the match to correlate the user input zip code with a zone leveraging the assigned zones 646 stored in the database 642. For example, a zip code in all zip codes 644 could be 02616 and the assigned zone for 02616 stored in assigned zones 646 can be Zone 1. If the user input zip code is 02616, that matches the 02616 zip code in all zip codes 644, and the zone zip code correlator 604 will assign the user input zip code 02616 the same zone as the matching zip code in all zip codes 644, Zone 1. The corresponding zone can be stored in the location zones 622 in the scheduling database 616.

Continuing to refer to FIG. 6 in more detail, the zone zip code correlator 604 of the data processing system 602 can determine what zone a photographer lives in based off of the photographers address, including its zip code. For example, the photographer can input a zip code via the control interface 676 of the capture application 674. The data processing system 602 can recognize a pattern, for example, a 5-digit number represents a zip code. The recognized zip code input by the photographer is stored in the contact information 640 of the photographer availability database 632. The zone zip code correlator 604 of the data processing system 602 compares the zip code input by the photographer and the zip codes stored in all zip codes 644 of the database 642 and finds a match. If there is no match, a new zone is created and stored in assigned zones 646 of database 642. Once there is a zip code match, the zone zip code correlator 604 of the data processing system 602 uses the match to correlate the photographer input zip code with a zone leveraging the assigned zones 646 stored in the database 642. For example, a zip code in all zip codes 644 could be 02616 and the assigned zone for 02616 stored in assigned zones 646 can be Zone 1. If the photographer input zip code is 02616, that matches the 02616 zip code in all zip codes 644, and the zone zip code correlator 604 will assign the photographer input zip code 02616 the same zone as the matching zip code in all zip codes 644, Zone 1. The corresponding zone can be stored in the photographer zones 634 in the photographer availability database 632.

Referring to FIG. 6 in more detail, the geopolitical area recognizer 606 can recognize an input that is not a zip code and determine what the zip code is. For example, a user can input a different area identifier, such as a geopolitical area, that represents the one location or the number of locations that the user has to capture. The geopolitical area can include regions such as a state in the United States, a province in Canada, a district within a state, such as the Back Bay in Massachusetts, or a similar area. The data processing system 602 can recognize the geopolitical area is different from a zip code and can store the geopolitical area in the location area identifier 620 of the scheduling database 616. The geopolitical area recognizer 606 of the data processing system 602 can access the geopolitical area stored in the location area identifier 620 and can perform a lookup in a third party database to identify the corresponding zip code. For example, the third party database can be a maps database. The geopolitical area recognizer 606 can compare the geopolitical area stored in the location area identifier 620 of the scheduling database 616 with the information in the third party database and finds a match. The geopolitical area recognizer 606 can leverage the data in the third party database and identify a zip code corresponding to the matched location. The zip code corresponding to the area identifier can be stored in the location zip codes 618 of the scheduling database 616 of the data processing system 602. Then, the zone zip code correlator 604 of the data processing system 602 of FIG. 6 can correlate the zip code with a zone, as described above.

Referring to FIG. 6 in more detail, the photographer zone assigner 608 of the data processing system 602 determines the geographic area, e.g., zone, the photographer will cover based off of the specific place the photographer lives. For example, the photographer zone assigner 608 leverages the results from the zone zip code correlator 604 of the data processing system 602 described above. For example, the zip code match that the zone zip code correlator 604 identified is leveraged and the corresponding zone that was stored in the photographer zones 634 represents the zone the photographer will cover, which is stored in the photographer zones 634 in the photographer availability database 632 of the data processing system. The photographer can input a single zip code or a plurality of zip codes and can thus be assigned a single zone or a plurality of zones.

Referring to FIG. 6 in more detail, the customer dashboard delivery controller 610 can render and provide a calendar view to the calendar viewer 658 of the customer dashboard 654 and a confirmation view to the confirmation viewer 660 of the customer dashboard 654, both on the customer device 650. The customer dashboard delivery controller 610 can receive a request from a customer device 650 for a calendar view or a confirmation view. For example, a customer application 652 (e.g., a web browser) executing on the customer device 650 can make a call or request to the data processing system 602 for a calendar viewer 658 or a confirmation viewer 660. The call can be made via JavaScript or iFrame to the data processing system 602. The customer dashboard delivery controller 610 can receive the JavaScript or iFrame call or request. The customer dashboard delivery controller 610 can provide the customer dashboard 654 of the customer device 650 with a viewer, 658 and/or 660. The customer dashboard delivery controller 610 can provide the customer dashboard 654 responsive to the request or call received from the customer device 650 via the network 101. The customer dashboard delivery controller 610 can provide the calendar view to the calendar viewer 658 of the customer dashboard 654 for viewing on the customer application 652 or customer device 650. The customer dashboard delivery controller 610 can provide the confirmation view to the confirmation viewer 660 of the customer dashboard 654 for viewing on the customer application 652 or customer device 650. The customer dashboard 654 executing on the customer device 650 can download the views for playback or rendering on the customer device 650.

Referring to FIG. 6 in more detail, the confirmation generator 612 can create a unified view of appointment information, send a confirmation email or text to a user (not shown), send a reconfirmation of an adjusted appointment to the user, send an appointment cancellation confirmation to the user, send a confirmation to a photographer (not shown), and send a reconfirmation nudge to the user. The confirmation generator 612 of the data processing system 602 can access all of the information and selections made by the user, which is stored in the scheduling database 616. The confirmation generator 612 can compile all of the information, or some of the information, and create a unified view, which can be characterized as the appointment and can be stored in the appointments 628 of the scheduling database 616 of the data processing system 602.

Continuing to refer to FIG. 6, the confirmation generator 612 of the data processing system 602 can send a confirmation email to the email address provided by the user that is stored in the contact information 624 of the scheduling database 616. The data processing system 602 can access the email address from the contact information 624 in the scheduling database 616 of the data processing system 602. The user can receive the confirmation email sent by the data processing system 602 in the email address the user provided. The confirmation email can include all information and selections made by the user stored in the user inputs 626 of the scheduling database 616. The confirmation generator 612 of the data processing system 602 can also send a text message sent to the phone number provided by the user that is stored in the contact information 624 of the scheduling database 616. The confirmation email or text message can be accessed on the customer device 650, which can be any electronic device capable of receiving emails and text messages, such as a mobile phone, laptop, or desktop computer. The customer dashboard 654 of FIG. 6 can send a confirmation email, which can be an email or a text message, to the user. The customer dashboard 654 is in communication with the data processing system 602. The data processing system 602 can provide the customer dashboard 654 with the email address and the phone number provided by the user from the contact information 624 of the scheduling database 616. In another embodiment, the customer dashboard 654 of FIG. 6 can display a confirmation to the user directly via the confirmation viewer 660.

Continuing to refer to FIG. 6, the confirmation generator 612 can send a reconfirmation of an adjusted appointment to the user and an appointment cancellation confirmation to the user. For example, a user can reschedule, adjust, or cancel a capture appointment that was confirmed in the confirmation email or text message via the control interface 656 of the customer dashboard 654 of FIG. 6. The confirmation generator 612 of the data processing system 602 can send an appointment adjustment confirmation email to the email address or a text message to the phone number provided by the user that is stored in the contact information 624 of the scheduling database 616.

Continuing to refer to FIG. 6, the confirmation generator 612 can send a confirmation to a photographer (not shown). The confirmation can include an appointment hyperlink that is linked to a calendar so that the appointment information creates an event in the calendar. The calendar can be accessed by the data processing system 602. The calendar can be accessed by the photographer (not shown). The calendar can be accessed by the backend 680. The calendar can be on a third party system (not shown). The confirmation can be an email sent to the email address provided by the photographer stored in contact information 640 in the photographer availability database 632 of data processing system 602. The confirmation can be a text message sent to the phone number provided by the photographer stored in contact information 640 in the photographer availability database 632 of data processing system 602. The data processing system 602 can access the email address and the phone number from contact information 640 in the photographer availability database 632 of data processing system 602. The confirmation can be accessed on the photographer device 670, which can be any electronic device capable of receiving emails and text messages, such as a mobile phone, laptop, or desktop computer.

Continuing to refer to FIG. 6, the confirmation generator 612 can send a reconfirmation nudge to the user. The reconfirmation nudge can be sent to the email address or a text message to the phone number provided by the user that is stored in the contact information 624 of the scheduling database 616.

Referring to FIG. 6 in more detail, the updater 614 of the data processing system 602 can update the data processing system 602, the customer dashboard 654, the capture application 674, and the backend 680 regarding the availability of photographers and the accepted, rejected, and unassigned bookings. The updater 614 is in communication with the customer dashboard 654. The updater 614 can send the updated availability of the photographers to the customer dashboard 654 such that the updated photographer availability is reflected in the calendar viewer 658 so that the user who is booking an appointment can see the up-to-date availability of the photographers. For example, if users book all available time slots such that there are no longer any available photographers, then the calendar viewer 658 will not display that time slot to latter users.

Continuing to refer to FIG. 6, both the capture application 674 and the backend 680 are in communication with the data processing system 602. The updater 614 of the data processing system 602 continuously and/or periodically updates the accepted, rejected, and unassigned bookings such that the availability of the photographers is sent to the customer dashboard 654 and the new availability of the photographers is reflected in the calendar viewer 658 so that the user who is booking an appointment can see the up-to-date availability of the photographers. As the users continue to schedule capture appointments, the updater 614 of the data processing system 602 updates the capture application 674 and the backend 680 so that the photographers and the scheduling coordinator 690 can see the up to date bookings. For example, the photographer can view the updated availability via the schedule viewer 678 of the capture application 674.

Referring to FIG. 6 in more detail, the scheduling database 616 is located in the data processing system 602 of FIG. 6. The scheduling database 616 can include a location zip codes 618, a location area identifier 620, a location zones 622, a contact information 624, a user inputs 626, an appointments 628, and a location capture time requirement 630. The time requirement 630 can refer to or include an estimated amount of time to perform a location capture, a suggested amount of time to perform a location capture, or a desired amount of time to perform a location capture. The scheduling database 616 can be in communication with the customer dashboard 654. The scheduling database 616 can include information input by a user (not shown). The user can input information into the customer dashboard 654 and the customer dashboard 654 can send it to the scheduling database 616 of the data processing system 602.

Still referring to FIG. 6, the location zip codes 618 can store the zip code input by the user and the zip code identified by the geopolitical area recognizer 606, as described above. The location area identifier 620 can store the geopolitical area input by the user, as described above. The location zones 622 can store the zone determined by the zone zip code correlator 604 as a result of the user zip code match and the zip code match in the all zip codes 644, as described above. The contact information 624 can store information a user input into the control interface 656 of the customer dashboard 654. For example, the information stored in contact information 624 can include an email address and/or a phone number. The user inputs 626 can store information a user input into the control interface 656 of the customer dashboard 654. For example, the information stored in user inputs 626 can include a DMO partner selection, a list of desired camera shots for each of the one location or the number of locations that the user has to schedule a capture of locate on attributes for, accessibility features, and/or the product package selection. The appointments 628 can store a unified view of all of the information and selections made by the user that are stored in the contact information 624 and the user inputs 626 of the scheduling database 616. The location capture time requirement 630 can store the calculated time for a capture, discussed below.

Referring to FIG. 6 in more detail, the photographer availability database 632 is located in the data processing system 602 of FIG. 6. The photographer availability database 632 can include a photographer zones 634, a photographer availability 636, a photographer schedule 638, and a contact information 640. The photographer availability database 632 can be in communication with the capture application 674. The photographer availability database 632 can include information input by a photographer (not shown). The photographer can input information into the capture application 674 and the capture application 674 can send it to the photographer availability database 632 of the data processing system 602. The information input by the photographer can include contact information, such as the name of the photographer, the phone number of the photographer, and the address the photographer lives at or otherwise works at. The photographer address can include the city and the state. The photographer address can include a zip code the photographer services. The photographer can provide multiple zip codes that the photographer services. The information input by the photographer can include availability information. The availability information input by the photographer can include the availability of the photographer for each zone. The availability of the photographer for each zone can be different or the same.

Still referring to FIG. 6, the photographer zones 634 can store the zone or zones the photographer will cover. The photographer availability 636 can store each photographer availability for each zone. The photographer schedule 638 can add and store the appointments 628 in the scheduling database 616 of the data processing system 602 once it has either been assigned to the photographer by the scheduling coordinator 690 or the photographer booked the appointment directly. The contact information 640 can be store the information input by the photographer via the control interface 676 of the capture application 674.

Referring to FIG. 6 in more detail, the database 642 can include all zip codes 644 and assigned zones 646. The all zip codes 144 can store zip codes uploaded by via the customer dashboard 654, the capture application 674, and/or the backend 680. The assigned zones 646 can store the zones created by the zone zip code correlator 604, as discussed above.

Still referring to FIG. 6, the customer device 650 of system 600 can include a customer application 652. The customer device 650 of system 600 can include a customer dashboard 654, which can include a control interface 656, a calendar viewer 658, and a confirmation viewer 660.

Referring to FIG. 6 in more detail, the system 600 can include, interface with or otherwise communicate with a customer device 650. The customer device 650 can be a laptop computing device, tablet computing device, smartphone, or something similar. The data processing system 602 can provide the customer dashboard 654 responsive to a request or call from the customer device 650. The data processing system 602 can stream content that includes the calendar and confirmation views. The customer device 650 can include one or more component or functionality depicted in FIG. 12. The customer device 650 can execute, host, or run a customer application 652.

Referring to FIG. 6 in more detail, the customer application 652 can include a native browser, web browser, or other application capable of or configured to access a website, domain, or other resource hosted or provided by a server, such as data processing system 602. The customer application 652 can include or be configured to process one or more network protocols in one or more programming languages. For example, the customer application 652 can parse or process hypertext markup language (HTML), javascript, or other scripts. The customer application 652 can navigate to or access a reference, address, or uniform resource locator. The customer application 652 can render HTML associated with the URL. The customer application 652 can trigger a call associated with the URL. For example, the customer dashboard 654, upon a page refresh, can make a call via javascript or iFrame to the data processing system 602. Responsive to the call, the customer application 652 can download the customer dashboard 654. The data processing system 602 (e.g., via the customer dashboard delivery controller 610) can provide the customer dashboard 654 to the customer application 652.

Referring to FIG. 6 in more detail, the customer dashboard 654 can be presented or provided within the customer application 652. The customer dashboard 654 can be presented on the customer device 650 within an iFrame or portion of the customer application 652. In some cases, the customer dashboard 654 can be presented in a separate window or pop-up on the customer device 650. In some cases, the customer dashboard 654 can open as a separate, native application executing on the customer device 650 that is separate from the customer application 652.

Continuing to refer to FIG. 6, the customer dashboard 654 can include a control interface 656. The customer dashboard 654 can present a control interface 656 designed, constructed and operational to provide user interface elements. The control interface 656 can provide buttons, widgets, or other user interface elements or other interactive icons. The control interface 656 can receive input from a user of the customer device 650. The control interface 656 can provide the user the ability to access the scheduling homepage and the purchasing page and click buttons (e.g., select the desired product package or click the book capture appointment button), to enter information (e.g., location zip codes, number of spaces in a location or in multiple locations that the user wishes to capture), to adjust a confirmed appointment (e.g., reschedule or cancel a confirmed booking), and to select a location type (e.g., multi-site locations, multi-venue locations, and/or a single location). In some cases, the control interface 656 can receive mouse down interactivity outside the frame of the customer application 652 in which the customer dashboard 654 is presenting a calendar view or confirmation view.

Continuing to refer to FIG. 6, the customer dashboard 654 can include a calendar viewer 658. The calendar viewer 658 can facilitate a smooth, seamless display of the calendar view. The calendar viewer 658 can display the photographer availability. The calendar viewer 658 can allow a user to schedule a capture of the location or locations that have a photographer in range. For example, a customer can access the customer dashboard 654 of FIG. 6 and schedule via the calendar viewer 658 a location attribute capture of the location or locations if the location or locations have a photographer assigned to that zone, e.g., geographic region. The customer dashboard 654 is in communication with the data processing system 602. The data processing system 602 provides the customer dashboard 654 with the availability of photographers in each of the zones. The calendar viewer 658 can display the photographer availability in dates and times. The times can be displayed in predetermined blocks of time, such as 30 minutes, 60 minutes, and/or 90 minutes.

Continuing to refer to FIG. 6, the customer dashboard 654 can include a confirmation viewer 660. The customer dashboard 654 can present a confirmation viewer 660 designed, constructed and operational to provide information and user interface elements. The confirmation viewer 160 can provide the confirmation page discussed above. The confirmation viewer 660 can provide buttons, widgets, or other user interface elements or other interactive icons. The confirmation viewer 660 can receive input from a user of the customer device 650. For example, the confirmation page can be reviewed by a user (not shown). Further, the user can confirm the booking by clicking a confirm booking button located on the confirmation page displayed by the confirmation viewer 660.

Still referring to FIG. 6, the photographer device 670 can include a photographer application 672. The photographer device 670 can include a capture application 674, which can include a control interface 676 and a schedule viewer 678.

Referring to FIG. 6 in more detail, the system 600 can include, interface with or otherwise communicate with a photographer device 670. The photographer device 670 can be a laptop computing device, tablet computing device, smartphone, or something similar. The data processing system 602 can provide the capture application 674 responsive to a request or call from the photographer device 670. The data processing system 602 can stream content that includes the calendar and confirmation views. The photographer device 670 can include one or more component or functionality depicted in FIG. 12. The photographer device 670 can execute, host, or run a photographer application 672.

Referring to FIG. 6 in more detail, the photographer application 672 can include a native browser, web browser, or other application capable of or configured to access a website, domain, or other resource hosted or provided by a server, such as data processing system 602. The photographer application 672 can include or be configured to process one or more network protocols in one or more programming languages. For example, the photographer application 672 can parse or process hypertext markup language (HTML), javascript, or other scripts. The photographer application 672 can navigate to or access a reference, address, or uniform resource locator. The photographer application 672 can render HTML associated with the URL. The photographer application 672 can trigger a call associated with the URL. For example, the capture application 674, upon a page refresh, can make a call via javascript or iFrame to the data processing system 602. Responsive to the call, the photographer application 672 can download the capture application 674. The data processing system 602 (e.g., via the customer dashboard delivery controller 610) can provide the capture application 674 to the photographer application 672.

Referring to FIG. 6 in more detail, the capture application 674 can be presented or provided within the photographer application 672. The capture application 674 can be presented on the photographer device 670 within an iFrame or portion of the photographer application 672. In some cases, the capture application 674 can be presented in a separate window or pop-up on the photographer device 670. In some cases, the capture application 674 can open as a separate, native application executing on the photographer device 670 that is separate from the photographer application 672.

Continuing to refer to FIG. 6, the capture application 674 can include a control interface 676. The capture application 674 can present the control interface 676 designed, constructed and operational to provide user interface elements. The control interface 676 can provide buttons, widgets, or other user interface elements or other interactive icons. The control interface 676 can receive input from a photographer of the photographer device 670. The control interface 676 can provide the photographer the ability to input their availability, input their contact information, initiate a confirmation nudge, and reject a booking assigned by a scheduling coordinator 690.

Continuing to refer to FIG. 6, the capture application 674 can include a schedule viewer 678. The photographer schedule, including bookings and availability, can be located in the schedule viewer 678 the capture application 674. The photographer schedule can be accessed by a photographer on the capture application 674. The photographer schedule can include the availability of the photographer such that the photographer can see their availability within their zone. The photographer schedule can include the bookings of the photographer such that the photographer can see their bookings within their zone. The photographer can service multiple zones and the schedule viewer 678 can display the photographer schedule for multiple zones.

Still referring to FIG. 6, the backend 680 can include a photographer availability database 682, which can include a photographer availability 684, a photographer schedule 686, and a photographer contact information 688. The backend 680 can include a scheduling coordinator 690. The backend 680 can include a flagger 692. The backend 680 can include a booking status tracker 694.

Referring to FIG. 6 in more detail, the scheduling coordinator 690 of the backend 680 can have access to the availability of the photographers that is stored in the photographer availability database 682 of the backend 680, discussed below. The scheduling coordinator 690 can assign bookings to photographers if there is a booking when a photographer is available.

Referring to FIG. 6 in more detail, the flagger 692 of the backend 680 can flag a cancelled booking and prompt a scheduling coordinator 690 to rebook the capture appointment with an available photographer. The unassigned booking will be available for other photographers to accept on the capture application 674.

Referring to FIG. 6 in more detail, the booking status tracker 694 of the backend 680 can track status of the cancelled or rejected booking and can notify the scheduling coordinator 690 if it is assigned and accepted or accepted without having been assigned.

Referring to FIG. 6 in more detail, the photographer availability database 682 of the backend 680 can include a photographer availability 684, a photographer schedule 686, and a photographer contact information 688. The photographer availability 684 can store the availability a photographer inputs via the control interface 676 of the capture application 674. The capture application 674 is in communication with the backend 680 and the data processing system 602. Each photographer has a user profile within the photographer availability 684 of the photographer availability database 682 in the backend 680 and the availability of each photographer can be stored in their corresponding user profiles on the backend 680.

Continuing to refer to FIG. 6, the photographer schedule 686 of the photographer availability database 682 can store the photographer schedule described above. For example, it can be the same updated schedule stored in the schedule viewer 678 of the capture application 674 and/or the photographer schedule 638 of the photographer availability database 632 of the data processing system 602. The photographer contact information 688 of the photographer availability database 682 can store the photographer contact information described above. For example, it can be the same contact information 640 stored in the photographer availability database 632 of the data processing system 602.

FIG. 7A depicts a flowchart of the location attribute capture process, in accordance with implementations. The flowchart can be categorized as a location attribute capture process 700. The location attribute capture process 700 can be performed by one or more system component of system 600 depicted in FIG. 6 or by one or more system component of system 300 depicted in in FIG. 12. The location attribute capture process 700 can include determining an unknown photographer is going to cover an unknown geographical location at 702. At 704, the location attribute capture process 700 can include a customer signing on and having at least one location, which can be in various areas. At 706, the location attribute capture process 700 can include a photographer living in a specific place and covering a geographic area, which can be defined by a zip code. This geographic area can be referred to as a zone. At 708, the location attribute capture process 700 can include allowing a customer to schedule a location attribute capture of the location or locations that have a photographer in range.

Still referring to FIG. 7A, and in further detail, the location attribute capture process 700 includes determining an unknown photographer is going to cover an unknown geographical location at 702. The data processing system 602 of FIG. 6 can assign an as of yet determined photographer to cover an as of yet determined geographic location or as of yet determined geographic locations.

At 704, a customer can sign on and provide at least one location, which can be in various areas. The data processing system can receive the location from a customer via a customer client device signing on or otherwise logging in or authenticating with the data processing system. For example, a customer can access the customer dashboard 654 of FIG. 6. In some embodiments, the customer can sign into the customer dashboard 654 of FIG. 6. The customer can have one location or a number of locations to schedule a capture of location attributes for. The location or locations can be in various locations or geographic areas.

At 706, the data processing system can determine or identify a zone in which a photographer is or lives. The data processing system can receive, from the photographer, input including contact information. Contact information can include the email address and phone number of the photographer. The data processing system can receive, from the photographer, availability information, such as the address or addresses including zip codes of the photographer, in the capture application 674 via the control interface 676. The data processing system 602 of FIG. 6 can store the contact information of the photographer in the contact information 640 of the photographer availability database 632 of FIG. 6. The backend 680 of FIG. 6 can store the contact information of the photographer in the photographer contact information 688 of the photographer availability database 682 of FIG. 6. The data processing system 602 of FIG. 6 can store the plurality of zones, which are defined by zip codes, in the photographer availability database 632 of FIG. 6. The data processing system 602 can determine in what zone the photographer lives based, at least in part, on the address (e.g., street address, zip code, etc.) of the photographer. The data processing system 602 can determine the geographic area, e.g., zone, the photographer will cover based off of the specific place the photographer lives.

At 708, the data processing system can allow a customer to schedule a location attribute capture of the location or locations that have a photographer in range. For example, a customer can access the customer dashboard 654 of FIG. 6 and schedule a location attribute capture of the location or locations if the location or locations have a photographer assigned to that zone, e.g., geographic region. The customer dashboard 654 is in communication with the data processing system 602. The data processing system 602 provides the customer dashboard 654 with the availability of photographers in each of the zones.

FIG. 7B depicts an illustration of multiple locations a customer may have to schedule captures for, in accordance with implementations. A customer may have one location to schedule a capture for or multiple locations to schedule a capture for. The multiple locations can be in different geographical areas, e.g., zones.

FIG. 8 depicts a flowchart of the scheduling flow process from the users' views, in accordance with implementations. The flowchart can be categorized as a scheduling flow user view process 800. The scheduling flow user view process 800 can be performed by one or more system component of system 600 depicted in FIG. 6 or by one or more system component of system 300 depicted in in FIG. 12. The scheduling flow user view process 800 can be implemented on the customer dashboard 654 of FIG. 6. The scheduling flow user view process 800 includes a scheduling homepage 802. The scheduling flow user view process 800 includes a schedule now button 804 a user can click. The scheduling flow user view process 800 includes an identify region 806. The scheduling flow user view process 800 includes a partner selection 808. The scheduling flow user view process 800 includes a calendar view 810. The scheduling flow user view process 800 includes a location information 812. The scheduling flow user view process 800 includes a confirmation page 814 for the booking. The scheduling flow user view process 800 includes a user confirmation email 820. The scheduling flow user view process 800 includes an appointment adjustment 822. The scheduling flow user view process 800 includes a photographer schedule 830 the booking can be added to. The scheduling flow user view process 800 includes a reconfirmation nudge 832.

Still referring to FIG. 8, and in further detail, the scheduling flow user view process 800 can include provide a scheduling homepage at 802. In some embodiments, the scheduling homepage 802 can be located on the customer dashboard 654 of FIG. 6. The scheduling homepage 802 can be accessed by a customer, e.g., a user, (not shown). The scheduling homepage 802 can be a link on the customer dashboard 654. The scheduling homepage 802 can be the first page of the customer dashboard 654. The scheduling homepage 802 includes the starting point of the scheduling flow user view process 800 for the user.

At 804, the data processing system can receive a selection, made by a user of a client device, of the schedule now button 804. In some embodiments, the data processing system can provide the schedule now button 804 on the scheduling homepage 802 of the customer dashboard 654 of FIG. 6. The schedule now button 804 can be clicked by a user (not shown). The schedule now button 804 can be a link to a new page on the customer dashboard 654 of FIG. 6. The schedule now button 804 can be any shape, such as a circle, square, or a rectangle. The schedule now button 804 can initiate a drop down menu on the scheduling homepage 802 of the customer dashboard 654 of FIG. 6.

At 806, the scheduling flow user view process 800 includes the identify region. In some embodiments, the identify region 806 can be located on the customer dashboard 654 of FIG. 6. The identify region 806 can be accessed by a user (not shown). The user can input a zip code, which the data processing system 602 of FIG. 6 correlates with a zone. The zip code can relate to the one location or the number of locations that the customer has to schedule a capture of location attributes for. The location or locations can be in various locations or geographic areas. The data processing system 602 can recognize a pattern, for example, a 5-digit number represents a zip code. The zip code input can be stored in the location zip codes 618 of the scheduling database 616 of the data processing system 602. In other embodiments, the user can input a different area identifier, such as a geopolitical area, that represents the one location or the number of locations that the customer has. For example, the geopolitical area can include regions such as a state in the United States, a province in Canada, a district within a state, such as the Back Bay in Massachusetts, or a similar area. The data processing system 602 can recognize the geopolitical area is different from a zip code and can perform a lookup in a third party database to identify the corresponding zip code. For example, the third party database can be a maps database. The data processing system 602 can leverage the third party database to identify the corresponding zip code, which can then be stored in the location zip codes 618 of the scheduling database 616 in the data processing system 602.

At 808, the data processing system can receive a partner selection. In some embodiments, the partner selection 808 can be located on the customer dashboard 654 of FIG. 6. The partner selection 808 can be accessed by a user (not shown). The user can select a destination marketing organization (DMO) partner. The data processing system 602 of FIG. 6 can select a DMO partner for the user. The user can input a list of desired camera shots for each of the one location or the number of locations that the customer has to schedule a capture of locate on attributes for. The user can input accessibility features. The DMO selection and the user inputs can be stored in the user inputs 626 of the scheduling database 616 of the data processing system 602. The user can input contact information, such as an email address and/or a phone number, which is stored in contact information 624 of the scheduling database 616 of the data processing system 602.

At 810, the data processing system can provide a calendar view. In some embodiments, the data processing system can provide the calendar view 810 in the calendar viewer 658 of the customer dashboard 654 of FIG. 6. The calendar view 810 can be accessed by a user (not shown). The customer dashboard 654 of FIG. 6 is in communication with the data processing system 602, which has the availability of numerous photographers assigned to a zone stored in photographer availability 636 of the photographer availability database 632. In some embodiments, the data processing system 602 is in communication with the backend 680 and receives the information regarding the availability of the photographers from the backend 680. The information can be stored in the photographer availability 684 in the of the photographer availability database 682 of the backend 680. The data processing system 602 can then store the information in photographer availability 636 of the photographer availability database 632 of the data processing system 602. In some embodiments, the data processing system 602 is in communication with the capture application 674 and receives the availability of the photographers from the capture application 674, which is then stored in photographer availability 636 of the photographer availability database 632 of the data processing system 602. The calendar view 810 can display dates and times. The times can be displayed in predetermined blocks of time, such as 30 minutes, 60 minutes, and/or 90 minutes. The calendar view 810 can display dates and times that photographers are available based on the photographer availability information stored in the photographer availability 636 of the photographer availability database 632 of the data processing system 602 or provided by the capture application 674. For example, the calendar view 810 will only display date and time blocks where at least one photographer is available so that the user can select only a date and a time block that has an available photographer. On the customer dashboard 654 of FIG. 1, the user can select a date and a time block on the date. The date and time block selection can be stored in the appointments 628 of the scheduling database 616 of the data processing system 602. The specific photographer will be assigned to the appointment of the capture later in the flowchart, as discussed in more detail below.

At 812, the data processing system can identify, provide, obtain, receive or otherwise determine the location information. In some embodiments, the location information 812 can be located in the customer dashboard 654 of FIG. 6. The location information 812 can be input by a user (not shown). For example, the user can input business information regarding the one location or the number of locations that the customer has to schedule a capture of location attributes for. Further, the business information can include an address and contact information. The business information input by the user can be stored in the contact information 624 of the scheduling database 616 of the data processing system 602.

At 814, the data processing system can provide a confirmation page for the booking. In some embodiments, the data processing system can provide the confirmation page 814 in confirmation viewer 660 of the customer dashboard 654 of FIG. 6. The confirmation page 814 can include some or all information and selections made by the user during the scheduling flow user view process 800 in a unified view. The confirmation page 814 can be reviewed by a user (not shown). Further, the user can confirm the booking by clicking a confirm booking button located on the confirmation page 814. The confirm booking button can be a link to a new page on the customer dashboard 654 of FIG. 6. The confirm booking button can be any shape, such as a circle, square, or a rectangle. The confirm booking button can initiate a drop down menu on the confirmation page 814 of the customer dashboard 654 of FIG. 6.

At 820, the data processing system can provide a user confirmation email. The confirmation generator 612 of the data processing system 602 can send a confirmation email to the email address provided by the user during partner selection 808. The data processing system 602 can access the email address from the contact information 624 in the scheduling database 616 of the data processing system 602. The user can receive the confirmation email sent by the data processing system 602 in the email address the user provided. The confirmation email can include some or all information and selections made by the user during the scheduling flow user view process 800. The confirmation generator 612 of the data processing system 602 can also send a text message sent to the phone number provided by the user during partner selection 808. The confirmation email or text message can be accessed on any electronic device capable of receiving emails and text messages, such as a mobile phone, laptop, or desktop computer. The data processing system can characterize the information and selections made by the user during the scheduling flow user view process 800 as the appointment and can be stored in the appointments 628 of the scheduling database 616 of the data processing system 602. The customer dashboard 654 of FIG. 6 can send a confirmation email 820, which can be an email or a text message, to the user. The customer dashboard 654 is in communication with the data processing system 602. The data processing system 602 can provide the customer dashboard 654 with the email address and the phone number provided by the user from the contact information 624 of the scheduling database 616. In another embodiment, the customer dashboard 654 of FIG. 6 can display a confirmation to the user directly.

At 822, the data processing system can adjust an appointment. In some embodiments, the data processing system can display and implement the appointment adjustment on the control interface 656 of the customer dashboard 654 of FIG. 6. The appointment adjustment 822 can be accessed by a user (not shown). The user can reschedule the appointment that was confirmed in the confirmation email or text message. The user can cancel the appointment that was confirmed in the confirmation email or text message. The confirmation generator 612 of the data processing system 602 can send an appointment adjustment confirmation email to the email address provided by the user during partner selection 808. The appointment adjustment confirmation email can be a text message sent by the data processing system 602 to the phone number provided by the user during partner selection 808.

At 830, the data processing system can establish, identify, determine, or provide the photographer schedule. The appointment stored in appointments 628 in the scheduling database 616 of the data processing system 602, which includes all of the information and selections made by the user during the scheduling flow user view process 800, can be added by the data processing system to the photographer schedule 830. In some embodiments, the photographer schedule 830 can be located in the schedule viewer 678 the capture application 674 of FIG. 6. In some embodiments, the photographer schedule 830 can be located in the photographer schedule 686 in the backend 680 of FIG. 6. In some embodiments, the photographer schedule 830 can be located in the photographer schedule 638 in the photographer availability database 632 in the data processing system 602 of FIG. 6. The photographer schedule 830 can be accessed by a photographer on the capture application 674. The photographer schedule 830 can include the availability of the photographer such that the photographer can see their availability within their zone. The confirmation generator 612 of the data processing system 602 can send a confirmation to the photographer. The confirmation can include an appointment hyperlink that is linked to a calendar so that the appointment information creates an event in the calendar. The calendar can be accessed by the data processing system 602. The calendar can be accessed by the photographer (not shown). The calendar can be accessed by the backend. The calendar can be on a third party system (not shown). The confirmation can be an email sent to the email address provided by the photographer stored in contact information 640 in the photographer availability database 632 of data processing system 602. The confirmation can be a text message sent to the phone number provided by the photographer stored in contact information 640 in the photographer availability database of data processing system 602. The data processing system 602 can access the email address and the phone number from contact information 640 in the photographer availability database 632 of data processing system 602. The confirmation can be accessed on any electronic device capable of receiving emails and text messages, such as a mobile phone, laptop, or desktop computer.

Still referring to FIG. 8, the scheduling flow user view process 800 includes the reconfirmation nudge 832. In some embodiments, the reconfirmation nudge 832 can be located in the capture application 674 of FIG. 6. In some embodiments, the reconfirmation nudge 832 can be implemented by a photographer on the capture application 674 via the control interface 676. In some embodiments, the reconfirmation nudge 832 can be implemented by a photographer on the photographer device 670. The photographer device 670 can be any electronic device capable of sending emails and text messages, such as a mobile phone, laptop, or desktop computer. In some embodiments, the reconfirmation nudge 832 can be implemented by the confirmation generator 612 of the data processing system 602. The reconfirmation nudge 832 can be sent to the user via an email or a text message. The reconfirmation nudge 832 can be an email sent to the email address provided by the user during partner selection 808. The reconfirmation nudge 832 can be a text message sent to the phone number provided by the user during partner selection 808. The data processing system 602 can access the email address and the phone number from the contact information 624 of the scheduling database 616 of the data processing system 602. The capture application 674 is in communication with the data processing system 602. The data processing system 602 can provide the capture application 674 with the email address and the phone number provided by the user stored in contact information 624 of the scheduling database 616 of the data processing system 602. The capture application 674 can provide the photographer with the email address and the phone number provided by the user stored in contact information 624 of the scheduling database 616 of the data processing system 602. The reconfirmation nudge 832 can be accessed on any electronic device capable of receiving emails and text messages, such as a mobile phone, laptop, or desktop computer.

FIG. 9 depicts a flowchart of the scheduling flow process, in accordance with implementations. The flowchart can be categorized as scheduling flow method 900. The scheduling flow method 900 can be performed by one or more system component of system 600 depicted in FIG. 6 or by one or more system component of system 300 depicted in in FIG. 12. The scheduling flow method 900 can be implemented on the customer dashboard 654 of FIG. 6. The scheduling flow method 900 can be used for multi-site locations, multi-venue locations, and/or a single location, described in more detail below. The scheduling flow method 900 includes a purchase page 902. The scheduling flow method 900 includes a customer and location type identification 904. The scheduling flow method 900 includes a product package selection 906. The scheduling flow method 900 includes a book capture appointment choice 908. The scheduling flow method 900 includes an identify region 910. The scheduling flow method 900 includes a space identifier 912. The scheduling flow method 900 includes a calendar view 914. The scheduling flow method 900 includes a location information 916. The scheduling flow method 900 includes a confirmation page 918. The scheduling flow method 900 includes a confirmation email 920. The scheduling flow method 900 includes an appointment adjustment 922. The scheduling flow method 900 includes a photographer schedule 930. The scheduling flow method 900 includes a reconfirmation nudge 932.

Still referring to FIG. 9, and in further detail, the scheduling flow method 900 includes a purchase page at 902. In some embodiments, the purchase page 902 can be located in the customer dashboard 654. The purchase page 902 can be accessed by a customer, e.g., a user, via the control interface 656 of the customer dashboard 654 of FIG. 6. The purchase page 902 can be a link on the customer dashboard 654. The purchase page 902 can be the first page of the customer dashboard 654. The purchase page 902 includes the starting point of the scheduling flow method 900 for the user.

At 904, the scheduling flow method 900 includes a customer and location type identification 904. In some embodiments, the customer and location type identification 904 can be located on the customer dashboard 654 of FIG. 6. The customer and location type identification 904 can be input and selected by a user via the control interface 656 of the customer dashboard 654. The user can input contact information, such as an email address and/or a phone number. The scheduling flow method 900 can be used for different location types, such as multi-site locations, multi-venue locations, and/or a single location. For example, the multi-site locations may include scheduling location attribute captures for multiple restaurants of a restaurant chain. The multiple restaurants can be throughout a geographic region covering a plurality of zones, such as the United States. The multiple restaurants can be throughout a single zone, such as all restaurants of a restaurant chain in the zone corresponding to zip code 02616. In another example, the multi-venue locations may include scheduling location attribute captures for all offices in a zone. The scheduling flow method 900 can be used for a combination of location types, such as multi-site locations and multi-venue locations. For example, the combination may include scheduling location attribute captures for multiple rides in a theme park that spans multiple zip codes. The zone can correspond to a zip code. The zone can be manually defined. The zone can be a geographic area, such as Back Bay in Boston, Mass. In yet another example, the single location can be a specific venue, such as a baseball stadium. The baseball stadium can have an address. In some embodiments, the control interface 656 of the customer dashboard 654 of FIG. 6 can display a different view for each location type (e.g., multi-site locations, multi-venue locations, and/or a single location). For example, the control interface 656 of the customer dashboard 654 of FIG. 6 can display multiple locations to be captured of the user, e.g., customer, in multiple zones. In another example, the control interface 656 of the customer dashboard 654 of FIG. 6 can display a single location to be captured of the user, e.g., customer, in a single zone. The location type can be stored in the user inputs 626 of the scheduling database 616 of the data processing system 602. The customer identification information can be stored in the contact information 624 of the scheduling database 616 of the data processing system 602.

At 906, the scheduling flow method 900 includes a product package selection 906. In some embodiments, the product package selection 906 can be located on the customer dashboard 654 of FIG. 6. The product package selection 906 can be accessed by a user via the control interface 656 of the customer dashboard 654. The user can select a product package via the control interface 656 of the customer dashboard 654. There can be multiple product packages to choose from. In an embodiment, the product package can depend on the number of tours the user would like to schedule for a single location. For example, each room, such as a gym, lobby, pool, or entrance of a facility can be characterized as a tour. In another embodiment, the product package can depend on the number of locations the user would like to capture. For example, the user can have three restaurants in one zone or throughout multiple zones that the user would like to capture. In yet another embodiment, the product package can depend on the number of locations the user would like to capture as well as the number of tours the user would like to schedule for each location. The selection of the product package can be stored in the user inputs 626 of the scheduling database 616 of the data processing system 602.

At 908, the scheduling flow method 900 includes a book capture appointment choice 908. In some embodiments, the book capture appointment choice 908 can be a button that the user can click via the control interface 656 of the customer dashboard 654. For example, the button can be a single button that, when clicked by the user, books the capture appointment. In another example, there can be two buttons that present a choice to the user, such as a yes button and a no button that are presented after a proposition is made to the user or a question is presented to the user. The book capture appointment choice 908 can be located on the purchase page 902 of the customer dashboard 654 of FIG. 6.

At 910, the scheduling flow method 900 includes an identify region 910. In some embodiments, the identify region 806 can be located on the customer dashboard 654 of FIG. 6. The identify region 910 can be accessed by a user via the control interface 656 of the customer dashboard 654. The user can input a zip code, which the zone zip code correlator 604 of the data processing system 602 of FIG. 6 correlates with a zone. The zip code can relate to the one location or the number of locations that the customer has to schedule a capture of location attributes for. The location or locations can be in various locations, e.g., geographic areas. The data processing system 602 can recognize a pattern, for example, a 5-digit number represents a zip code. The zip code input can be stored in the location zip codes 618 of the scheduling database 616 of the data processing system 602. In other embodiments, the user can input a different area identifier, such as a geopolitical area, that represents the one location or the number of locations that the customer has. For example, the geopolitical area can include regions such as a state in the United States, a province in Canada, a district within a state, such as the Back Bay in Massachusetts, or a similar area. The data processing system 602 can recognize the geopolitical area is different from a zip code and can perform a lookup in a third party database to identify the corresponding zip code. For example, the third party database can be a maps database. The data processing system 602 can leverage the third party database to identify the corresponding zip code, which can then be stored in the location zip codes 618 of the scheduling database 616 in the data processing system 602.

At 912, the scheduling flow method 900 includes a space identifier 912. In some embodiments, the space identifier 912 can be located on the customer dashboard 654 of FIG. 6. The user can determine the number of spaces in a location or in multiple locations that the user wishes to capture. For example, the user may identify five spaces, which can be categorized as rooms, the user wishes to capture. The user may identify the area in each space, such as the square footage. The number and area of spaces desired translates to the amount of time required for the appointment or the appointments. The user can input the amount of spaces and/or the area of the spaces desired via the control interface 656 of the customer dashboard 654. The space identifier 912 on the customer dashboard 654 can calculate the amount of time that will be required by the photographer for the capture appointment and report it to the user via the control interface 656 of the customer dashboard 654. For example, a user may wish to capture a convention center and based off of the number and area of spaces the customer dashboard 654 may calculate that five hours, e.g., 800 minutes, will be required by the photographer for the capture appointment. The customer dashboard 654 can report that the time required for the capture is five hours, e.g., 800 minutes. The calculated time required can be stored in the location capture time requirement 630 of the scheduling database 616 of the data processing system 602.

At 914, the scheduling flow method 900 includes a calendar view 914. In some embodiments, the calendar view 914 can be located in the calendar viewer 658 of the customer dashboard 654 of FIG. 6. The calendar view 914 can be accessed by a user (not shown). The customer dashboard 654 of FIG. 6 is in communication with the data processing system 602, which has the availability of numerous photographers assigned to a zone stored in photographer availability 636 of the photographer availability database 632. In some embodiments, the data processing system 602 is in communication with the backend 680 and receives the information regarding the availability of the photographers from the backend 680. The information can be stored in the photographer availability 684 in the of the photographer availability database 682 of the backend 680. The data processing system 602 can then store the information in photographer availability 636 of the photographer availability database 632 of the data processing system 602. In some embodiments, the data processing system 602 is in communication with the capture application 674 and receives the availability of the photographers from the capture application 674, which is then stored in photographer availability 636 of the photographer availability database 632 of the data processing system 602. The calendar view 810 can display dates and times. The times can be displayed in predetermined blocks of time, such as 30 minutes, 60 minutes, and/or 90 minutes. The calendar view 810 can display dates and times that photographers are available based on the photographer availability information stored in the photographer availability 636 of the photographer availability database 632 of the data processing system 602 or provided by the capture application 674. For example, the calendar view 810 will only display date and time blocks where at least one photographer is available so that the user can select only a date and a time block that has an available photographer. On the customer dashboard 654 of FIG. 1, the user can select a date and a time block on the date. The date and time block selection can be stored in the appointments 628 of the scheduling database 616 of the data processing system 602. The specific photographer will be assigned to the appointment of the capture later in the flowchart, as discussed in more detail below.

At 916, the scheduling flow method 900 includes a location information 916. In some embodiments, the location information 916 can be located on the customer dashboard 654 of FIG. 6. The location information 916 can be input by a user (not shown). For example, the user can input business information regarding the one location or the number of locations that the customer has to schedule a capture of location attributes for. Further, the business information can include an address and contact information. The business information input by the user can be stored in the contact information 624 of the scheduling database 616 of the data processing system 602.

At 918, the scheduling flow method 900 includes a confirmation page 918. In some embodiments, the confirmation page 918 can be located on the customer dashboard 654 of FIG. 6. The confirmation page 918 can include all information and selections made by the user during the scheduling flow method 900 in a unified view. The confirmation page 918 can be reviewed by a user (not shown). Further, the user can confirm the booking by clicking a confirm booking button located on the confirmation page 918. The confirm booking button can be any shape, such as a circle, square, or a rectangle. The confirm booking button can be a link to a new page on the customer dashboard 654 of FIG. 6. The confirm booking button can initiate a drop down menu on the confirmation page 918 of the customer dashboard 654 of FIG. 6.

At 920, the scheduling flow method 900 includes a confirmation email 920 sent to the user. The confirmation generator 612 of the data processing system 602 can send a confirmation email to the email address provided by the user during customer and location type identification 904. The data processing system 602 can access the email address from the contact information 624 in the scheduling database 616 of the data processing system 602. The user can receive the confirmation email 920 sent by the data processing system 602 in the email address the user provided. The confirmation email 920 can include all information and selections made by the user during the scheduling flow method 900. The confirmation email 920 can also be a text message sent to the phone number provided by the user during customer and location type identification 904. The confirmation email 920 can be accessed on any electronic device capable of receiving emails and text messages, such as a mobile phone, laptop, or desktop computer. All of the information and selections made by the user during the scheduling flow method 900 can be characterized as the appointment and can be stored in the appointments 628 of the scheduling database 616 of the data processing system 602. The customer dashboard 654 of FIG. 6 can send a confirmation email 920, which can be an email or a text message, to the user. The customer dashboard 654 is in communication with the data processing system 602. The data processing system 602 can provide the customer dashboard 654 with the email address and the phone number provided by the user from the contact information 624 of the scheduling database 616. In another embodiment, the customer dashboard 654 of FIG. 6 can display a confirmation email 920 to the user directly.

At 922, the scheduling flow method 900 includes an appointment adjustment. In some embodiments, the appointment adjustment 822 can be displayed and implemented on the control interface 656 of the customer dashboard 654 of FIG. 6. The appointment adjustment 922 can be accessed by a user (not shown). The user can reschedule the appointment that was confirmed in the confirmation email. The user can cancel the appointment that was confirmed in the confirmation email. The confirmation generator 612 of the data processing system 602 can send an appointment adjustment confirmation email to the email address provided by the user during customer and location type identification 904. The appointment adjustment confirmation email can be a text message sent by the data processing system 602 to the phone number provided by the user during customer and location type identification 904.

At 930, the scheduling flow method 900 includes a photographer schedule. The appointment stored in appointments 628 in the scheduling database 616 of the data processing system 602, which includes all of the information and selections made by the user during the scheduling flow method 900, can be added to the photographer schedule 930. In some embodiments, the photographer schedule 930 can be located in the schedule viewer 678 the capture application 674 of FIG. 6. In some embodiments, the photographer schedule 930 can be located in the photographer schedule 686 in the backend 680 of FIG. 6. In some embodiments, the photographer schedule 930 can be located in the photographer schedule 638 in the photographer availability database 632 in the data processing system 602 of FIG. 6. The photographer schedule 930 can be accessed by a photographer on the capture application 674. The photographer schedule 930 can include the availability of the photographer such that the photographer can see their availability within their zone. The confirmation generator 612 of the data processing system 602 can send a confirmation to the photographer. The confirmation can include an appointment hyperlink that is linked to a calendar so that the appointment information creates an event in the calendar. The calendar can be accessed by the data processing system 602. The calendar can be accessed by the photographer (not shown). The calendar can be accessed by the backend. The calendar can be on a third party system (not shown). The confirmation can be an email sent to the email address provided by the photographer stored in contact information 640 in the photographer availability database 632 of data processing system 602. The confirmation can be a text message sent to the phone number provided by the photographer stored in contact information 640 in the photographer availability database 632 of data processing system 602. The data processing system 602 can access the email address and the phone number from contact information 640 in the photographer availability database 632 of data processing system 602. The confirmation can be accessed on any electronic device capable of receiving emails and text messages, such as a mobile phone, laptop, or desktop computer.

At 932, the scheduling flow method 900 includes providing a reconfirmation nudge. In some embodiments, the reconfirmation nudge 932 can be located on the capture application 674 of FIG. 6. In some embodiments, the photographer schedule 930 can be located in the data processing system 602 of FIG. 6. In some embodiments, the reconfirmation nudge 932 can be implemented by a photographer on the capture application 674 via the control interface 676. In some embodiments, the reconfirmation nudge 932 can be implemented by a photographer on the photographer device 670. T The photographer device 670 can be any electronic device capable of sending emails and text messages, such as a mobile phone, laptop, or desktop computer. In some embodiments, the reconfirmation nudge 932 can be implemented by the confirmation generator 612 of the data processing system 602. The reconfirmation nudge 932 can be sent to the user via an email or a text message. The reconfirmation nudge 932 can be an email sent to the email address provided by the user during customer and location type identification 904. The reconfirmation nudge 932 can be a text message sent to the phone number provided by the user customer and location type identification 904. The data processing system 602 can access the email address and the phone number from the contact information 624 of the scheduling database 616 of the data processing system 602. The capture application 674 is in communication with the data processing system 602. The data processing system 602 can provide the capture application 674 with the email address and the phone number provided by the user stored in contact information 624 of the scheduling database 616 of the data processing system 602. The capture application 674 can provide the photographer with the email address and the phone number provided by the user stored in contact information 624 of the scheduling database 616 of the data processing system 602. The reconfirmation nudge 932 can be accessed on any electronic device capable of receiving emails and text messages, such as a mobile phone, laptop, or desktop computer.

FIG. 10 depicts a flowchart of the scheduling flow process from the data's view, in accordance with implementations. The flowchart can be categorized as scheduling flow data view 1000. The scheduling flow data view 1000 can be performed by one or more system component of system 600 depicted in FIG. 6 or by one or more system component of system 300 depicted in in FIG. 3. The scheduling flow data view 1000 includes a zone creator 1010. The scheduling flow data view 1000 includes a match to licensee 1012. The scheduling flow data view 1000 includes availability 1014. The scheduling flow data view 1000 includes a bookings begin 1016. The scheduling flow data view 1000 includes an update 1018. The scheduling flow data view 1000 includes photographer recruitment 1020. The scheduling flow data view 1000 includes photographer certified 1022. The scheduling flow data view 1000 includes photographer availability input 1024. The scheduling flow data view 1000 includes photographer rejection 1026. The scheduling flow data view 1000 includes bookings continue 1030.

Still referring to FIG. 10, the scheduling flow data view 1000 includes a zone creator 1010. Zip codes can be uploaded and stored in all zip codes 644 of the database 642 of the data processing system 602. The zip codes can be uploaded via the customer dashboard 654, the capture application 674, and/or the backend 680. The zone zip code correlator 604 of the data processing system 602 can create zones using the zip codes uploaded and stored in the database 642. The data processing system 602 can store the corresponding zones in the assigned zones 646 in the database 642 of the data processing system 602. For example, the corresponding zones represent what zones correspond with specific zip codes.

At 1012, the scheduling flow data view 1000 includes a match to licensee. A licensee can be anyone who uses or is a part of the system 600 or the methods 700, 800, 900, and/or 6000. The match to licensee 1012 of the data processing system 602 can match the zip code or zip codes to the licensee. For example, a licensee can be a photographer and the match to licensee 1012 can match multiple zip codes to the photographer. In another example, a licensee can be a photographer and the match to licensee 1012 can match a single zip code to the photographer. The photographer will service the zip codes matched to the photographer by the match to licensee 1012.

At 1014, the scheduling flow data view 1000 includes availability. The availability 1014 reflects the availability of each photographer to capture location attributes. The availability of each photographer is stored in the photographer availability 636 of the photographer availability database in the data processing system 602. In an embodiment, photographer availability can be by day and time. For example, a photographer can be available Tuesday (T), Wednesday (W), and Thursday (R) from 8 am to 5 pm EST. In another embodiment, photographer availability can be by amount of time in a day. For example, the photographer can be available for 5 hours on Monday (M).

Still referring to FIG. 10, the scheduling flow data view 1000 includes a bookings begin 1016. The bookings begin 1016 can be implemented on the customer dashboard by a user (not shown). The bookings begin 1016 can follow the 700, 800, and 900 methods for scheduling.

Still referring to FIG. 10, the scheduling flow data view 1000 includes an update 1018. The update 1018 is implemented by the updater 614 of the data processing system 602. The update 1018 is sent to the customer dashboard 654 and the new availability of the photographers is reflected in the calendar views 810 and 914 of the scheduling flow user view process 800 and the scheduling flow method 900, respectively so that the user who is booking an appointment can see the up-to-date availability of the photographers. For example, if a user books a capture appointment for a given time and date on the customer dashboard, then the photographer that is assigned to that capture is no longer available and the availability of that photographer changes from available to unavailable. In another example, if users book capture appointments at 2 pm on the same Friday such that all photographers in a zone are assigned to capture the multiple appointments, then the time slot for 2 pm on that Friday is no longer available for any user and the calendar views 810 and 914 will no longer display 2 pm on that Friday as a booking option the user can select.

Still referring to FIG. 10, the scheduling flow data view 1000 includes photographer recruitment 1020. Photographer recruitment can include a variety of recruitment means, such as job fairs, job postings, direct job solicitation, and/or the like. Photographer recruitment 1020 can be implemented manually or digitally.

Still referring to FIG. 10, the scheduling flow data view 1000 includes photographer certified 1022. During the photographer certified 1022 step, each of the photographers who were recruited during photographer recruitment 1020 are certified according to certain standards. For example, the certification can be given if a recruited photographer completes a certain number of courses. The courses can relate to real estate photography. The number of courses required for the certification can vary. For example, the number of required courses can be 3, 5, and/or 10. The length of time of the courses can vary. For example, each course can be 5 hours long. The courses do not have to be the same length of time. The certification can require that the courses be completed within a certain amount of time as each other. For example, all required courses must be completed within 3 months. The certification can expire such that recertification is required. For example, the certification can expire after 1 year such that recertification is required once a year.

Still referring to FIG. 10, the scheduling flow data view 1000 includes photographer availability input 1024. Each photographer can input his or her availability in the capture application 674 via the control interface 676. Each photographer can change his or her availability in the capture application 674 via the control interface 676. The capture application 674 is in communication with the backend 680 and the data processing system 602. The photographer availability can be stored in the photographer availability 636 of the photographer availability database 632 of the data processing system 602 and/or the photographer availability database 682 of the backend 680. Each photographer has a user profile within the photographer availability 684 of the photographer availability database 682 in the backend 680. The availability of each photographer can be stored in their corresponding user profiles on the backend. The photographer can input his or her availability by day and time. For example, a photographer can be available Tuesday (T), Wednesday (W), and Thursday (R) from 8 am to 5 pm EST. In another embodiment, the photographer can input his or her availability by amount of time in a day. For example, the photographer can be available for 5 hours on Monday (M). Each photographer can see appointments on the capture application 674 via the control interface 676 that were made by the users on the customer dashboard 654. Each photographer can accept appointments on the capture application 674 via the control interface 676 that were made by the users on the customer dashboard 654. Scheduling coordinator 690 of the backend 680 can have access to the availability of the photographers that is stored in the photographer availability database 682 of the backend 680. Scheduling coordinator 690 can assign bookings to photographers if there is a booking when a photographer is available.

Still referring to FIG. 10, the scheduling flow data view 1000 includes photographer rejection 1026. In the capture application 674 via the control interface 676, each photographer can reject a booking that has been assigned to them by the scheduling coordinator 690. In the capture application 674, each photographer can cancel a booking that they previously accepted. The capture application 674 is in communication with the data processing system 602 and the backend 680. If a photograph cancels or rejects a booking, then the flagger 692 of the backend 680 will flag the booking and prompt a scheduling coordinator 690 to rebook the capture appointment with an available photographer. The unassigned booking will be available for other photographers to accept on the capture application. The booking status tracker 694 of the backend 680 can track status of the canceled or rejected booking and can notify the scheduling coordinator 690 if it is assigned and accepted or accepted without having been assigned.

Still referring to FIG. 10, the scheduling flow data view 1000 includes bookings continue 1030. Both the capture application 674 and the backend 680 are in communication with the data processing system 602. The updater 614 of the data processing system 602 continuously and/or periodically updates the accepted, rejected, and unassigned bookings such that the availability of the photographers is sent to the customer dashboard 654 and the new availability of the photographers is reflected in the calendar views 810 and 914 of the scheduling flow user view process 800 and the scheduling flow method 900, respectively so that the user who is booking an appointment can see the up-to-date availability of the photographers. As the users continue to schedule capture appointments, the updater 614 of the data processing system 602 updates the capture application 674 and the backend 680 so that the photographers and the scheduling coordinator 690 can see the up to date bookings.

FIG. 11 depicts a flowchart of the scheduling flow process from a stack view, in accordance with implementations. The flowchart can be categorized as scheduling flow stack view 1100. The scheduling flow stack view 1100 can be performed by one or more system component of system 600 depicted in FIG. 6 or by one or more system component of system 300 depicted in in FIG. 12. The scheduling flow stack view 1100 includes a scheduling database 1110. The scheduling flow stack view 1100 includes a zip code 1112. The scheduling flow stack view 1100 includes a photographer availability database 1120. The scheduling flow stack view 1100 includes an availability calendar 1122. The scheduling flow stack view 1100 includes a zip code 1124. The scheduling flow stack view 1100 includes a zone 1130. The scheduling flow stack view 1100 includes an end user availability view 1132. The scheduling flow stack view 1100 includes a confirmation page 1134.

Still referring to FIG. 11, the scheduling flow stack view 1100 includes a scheduling database 1110. The scheduling database 1110 is located in the data processing system 602 of FIG. 6 and can be in communication with the customer dashboard 654. The scheduling database 1110 can include information input by a user (not shown). The user can input information into the customer dashboard 654 and the customer dashboard 654 can send it to the scheduling database 1110 of the data processing system 602. The information input by the user can include booking information, such as the name of the customer and the address of the location to be captured. The address of the location to be captured can include the city and the state the location is in. The address of the location to be captured can include the zip code the location is in. The information input by the user can include customer contact information, such as the email address and phone number of the customer.

Still referring to FIG. 11, the scheduling flow stack view 1100 includes a zip code 1112. The data processing system 602 can recognize the zip code that is in the scheduling database 1110. The zip code information is extracted from the scheduling database 1110 and the zip code can be categorized as zip code 1112.

At 1120, the scheduling flow stack view 1100 can include establishing, updating, identifying, or otherwise accessing a photographer availability database. The photographer availability database 1120 is located in the data processing system 602 of FIG. 6 and can be in communication with the capture application 674. The photographer availability database 1120 can include information input by a photographer (not shown). The photographer can input information into the capture application 674 and the capture application 674 can send it to the photographer availability database 1120 of the data processing system 602. The information input by the photographer can include contact information, such as the name of the photographer, the phone number of the photographer, and the address the photographer lives at or otherwise works at. The photographer address can include the city and the state. The photographer address can include a zip code the photographer services. The photographer can provide multiple zip codes that the photographer services. The information input by the photographer can include availability information. The availability information input by the photographer can include the availability of the photographer for each zone. The availability of the photographer for each zone can be different or the same.

At 1122, the scheduling flow stack view 1100 can include the data processing system providing an availability calendar. The photographer can input the availability information that is stored in the photographer availability database 1120 first into the availability calendar 1122 via the control interface 676 of the capture application 674. The capture application 674 is in communication with the photographer availability database 1120 of the data processing system 602 and can send the availability information to the data processing system 602 where it is stored in the availability calendar 1122. In an embodiment, photographer availability can be by day and time. For example, a photographer can be available Tuesday (T), Wednesday (W), and Thursday (R) from 8 am to 5 pm EST. In another embodiment, photographer availability can be by amount of time in a day. For example, the photographer can be available for 5 hours on Monday (M). The photographer availability can be the same for each zone the photographer services. The photographer availability can be different for each zone the photographer services.

Still referring to FIG. 11, the scheduling flow stack view 1100 includes a zip code 1124. The data processing system 602 can recognize the zip code that is in the photographer availability database 1120. The zip code information is extracted from the photographer availability database 1120 and the zip code can be categorized as zip code 1124.

Still referring to FIG. 11, the scheduling flow stack view 1100 includes a zone 1130. The data processing system 602 designates each zip code 1112 and 1124 to a zone. If the zone assigned to zip code 1112 matches the zone assigned to zip code 1124, then that zone can be categorized as 1130.

Still referring to FIG. 11, the scheduling flow stack view 1100 includes an end user availability view 1132. The end user availability view 1132 depicts the photographer availability for the booking input in the scheduling database 1110. The end user availability view 1132 will only provide availability time slots for photographers servicing zone 1130. The time availability time slots can be in blocks of time. The blocks of time can be uniform, such as each block is 90 minutes. The blocks of time can be different, such that a block can be 90 minutes and another block can be 30 minutes.

At 1134, the scheduling flow stack view 1100 can include the data processing system providing a confirmation page 1134. In some embodiments, the confirmation page 1134 can be located on the customer dashboard 654 of FIG. 6. The confirmation page 1134 can include all information and selections made by the user in a unified view. The confirmation page 1134 can be reviewed by a user (not shown). Further, the user can confirm the booking by clicking a confirm booking button located on the confirmation page 1134. The confirm booking button can be a link to a new page on the customer dashboard 654 of FIG. 6. The confirm booking button can be any shape, such as a circle, square, or a rectangle. The confirm booking button can initiate a drop down menu on the confirmation page 1134 of the customer dashboard 654 of FIG. 6.

An aspect can be generally directed to registering and referencing images and/or a sequence of images on a digitally distributed, decentralized, public or private ledger. This technical solution can create an image sequence, such as a virtual tour. This technical solution can register the image sequence and individual images on a digitally distributed, decentralized, public or private ledger, such as a blockchain. This technical solution can store the individual images and/or image sequences on a large-scale server that supports the ledger files, such as IPFS. This technical solution can reference the individual images and/or image sequences as appropriate by making calls to the ledger. This technical solution can make attributions to the owner of the individual images and/or image sequences.

This technical solution can create a virtual tour by automatically connecting panoramic images by associating a visual position and direction between correlative panoramic images or video media to generate a smooth, seamless camera path between the different panoramic images. The generated camera path is used to generate a virtual tour.

To do so, the data processing system of this technical solution can receive independent panoramic images or video from a client device. The data processing system can use iteration to surface key datasets from image-level noise, and create a directional connection between the panoramic images. The data processing system can be configured with a feature detection technique to facilitate generating the virtual tours. The data processing system can be configured with one or more feature detection technique, including, for example, a scale-invariant feature transform (“SIFT”), speeded up robust features (“SURF”), AKAZE, or BRISK. The data processing system can use a combination of octave and octave layers, scale factor, sigma values, and feature limiters to extract the target datasets.

To facilitate generating virtual tours, the data processing system can explicitly control and persist digital camera position to connect a set of panoramic images. The data processing system can register, visually associate, and persist the order of a set of panoramic media so as to create a virtual tour.

The data processing system can further automatically generate characteristics for the virtual tour. For example, the data processing system can provide a linear directional method that constraints the virtual tour camera path to forwards and backwards. The data processing system can provide an animation where each step through a sequence can begin with an automated camera pan—on one or both sides. The data processing system can provide an interruptible interactive experience, such as the ability to lean-back or lean-forward. As part of the transition, the data processing system can provide a method for camera control editing camera position.

The data processing system can provide a method for establishing key camera pose or bearing for the sake of panoramic connection. To do so, the data processing system can determine the pose or bearing of cameras given current registration as seen by another image. The data processing system can use the bearing information to author the direction of travel. To determine the bearings, the data processing system can be configured with a pose extraction technique. The pose extraction technique can include or be based on an comparing or fading two images, and identifying or finding the camera position based on the second image. The data processing system can perform pose extraction by handling spherical or epipolar geometry, in addition to flat images, and can provide fully-automated direct connection (automated).

Thus, the data processing system of this technical solution can establish a balance between automatic playback and interruptability of a virtual tour that is constrained to forwards/backwards movement without any branching. The data processing system can automatically connect panoramic images and can prioritize the camera path in order to generate the virtual tour with a fixed speed (e.g., 3 seconds per image). The data processing system can be configured with a machine learning technique to automatically align images. For example, the data processing system can use machine learning to make use of saved data, such as images of doors, to regularly refine and improve the image correlation. The machine learning program can identify an object, e.g., a door, as a digital image based on the intensity of the pixels in black and white images or color images. The machine learning program can identify objects, such as doors, with more reliability over time because it leverages the objects, e.g., doors, it already identified. Likewise, the machine learning program can match images of doors from third party databases with images of doors from internal databases more reliably over time because it leverages the matches it already identified. At connection time, the data processing system can provide an option to change path or pan to render another frame. For example, the data processing system can generate the virtual tour with a camera path that can automatically turn left or right. The data processing system can automatically generate characteristics for inclusion in the virtual tour, including, for example, chevrons or other icons that indicate directionality or interactivity. The chevron-style control provided by the data processing system can move the virtual tour in a linear direction, such as uniquely back and forth, through the tour.

For example, the data processing system can deliver a viewer application for rendering in a client application (e.g., a web browser) on a client device (e.g., laptop computing device, tablet computing device, smartphone, etc.). The data processing system can provide the viewer application responsive to a request or call from the client device. The data processing system can stream content that includes the panoramic images and metadata on the panoramic images. The viewer application executing on the client device can automatically initiate playback of the virtual tour upon receipt of the streamlining content, and provide a control interface for the user to control certain aspects of the virtual tour during playback.

FIG. 12 depicts a block diagram of an illustrative system for registering and referencing images and/or a sequence of images on a digitally distributed, decentralized, public or private ledger, in accordance with an embodiment. The system 1200 can include at least one data processing system 1202 for use in registering and referencing images and/or a sequence of images on a digitally distributed, decentralized, public or private ledger as well as creating a virtual tour. The data processing system 1202 can include a blockchain register 1204. The data processing system 1202 can include an asset caller 1206. The data processing system 1202 can include a sequence builder 1208. The data processing system 1202 can include an NFT attributer 1209. The data processing system 1202 can include an NFT updater 1210. The data processing system 1202 can include a data authenticator 1211. The data processing system 1202 can include a location associator 1212. The data processing system 1202 can include an interface 1258. The data processing system 1202 can include an image iterator 1264. The data processing system 1202 can include an image feature detector 1266. The data processing system 1202 can include a camera bearing controller 1268. The data processing system 1202 can include a characteristic generator 1260. The data processing system 1202 can include a viewer delivery controller 1262. The data processing system 1202 can include a data repository 1214, which can include or store a session ID 1216, a blockchain map data structure 1218, an asset data 1220, and a geographic regions data structure 1222. The data processing system 1202 can include hardware or a combination of hardware and software, such as communications buses, circuitry, processors, communications interfaces, among others. The data processing system 1202 can include one or more servers, such as a first server and a second server. The one or more servers can be located in a data center, one or more data centers, or geographically dispersed.

Referring to FIG. 12 the data processing system 1202 can include an image iterator 1264 designed, constructed and operational to surface key data sets from image-level noise. The image iterator 1264 can be configured with one or more techniques to identify key data sets from the image-level noise. The image iterator 1264, using these techniques, can create a directional connection between the images. For example, the image iterator 1264 can access internal image data stored in a database (not shown), process the images to remove image-level noise, and then determine a directional connection between the images. A directional connection can refer to a camera path or transition from a first image to a second image. The image iterator 1264 can control and persist a digital camera position through the panoramic connection set.

Further, the image iterator 1264, using the techniques to identify key data sets from the image-level noise, can create a set of key data sets. For example, the image iterator 1264 can access image data or geoposition data stored in the database (not shown), process the images to remove image-level noise, and then create a set of key data.

The image iterator 1264 can establish, set, generate or otherwise provide image transitions for the virtual tour. The data processing system can build visual image transitions during the creation of the virtual tour. To do so, the data processing system 1202 can use a tweened animation curve. A tweened animation curve can include generating intermediate frames between two frames in order to create the illusion of movement by smoothly transitioning one image to another. The data processing system 1202 can use the tweened animation curve to increase or maximize the sense of forward motion between images, relative to not using tweened animations.

The image iterator 1264 can perform tweening in a manner that preserves the spatial orientation. For example, the data processing system 1202 can position a virtual camera at an entrance of a cube, such as a second cube. The data processing system 1202 can move a previous scene forwards and past the viewer while fading out, and move the second scene in (e.g., overlapping) while fading in. This overlap can correspond to, refer to, represent, or symbolize linear editing techniques. For a door transition, the data processing system 1202 can fade the door as the viewer passes through the door.

The data processing system 1202 can include an image feature detector 1266 designed, constructed and operational to identify features from the images or sequence of the images. The feature detector can be configured with various feature detection techniques, including, for example, one or more of SIFT, SURF, AKAZE, and BRISK. The image feature detector 1266 can use a combination of octave and octave layers, scale factors, sigma values, and feature limiters to extract the target data sets. For example, the image feature detector 1266 can receive the key data sets surfaced from image-level noise by the image iterator 1264, and then detect features in the key data sets.

The image feature detector 1266 can perform image processing on the images to identify features or objects. For example, the image feature detector 1266 can detect doors. The data processing system 1202 can cast rays to corner points of the door and determine which faces are identified or hit. Since door images can be spread on up to four different cub faces, for example, the data processing system 1202 casts the rays to the corner points to identify which faces are hit. The data processing system 1202 can then dynamically create an alpha mask in a canvas based on those coordinates. The data processing system 1202 can apply this alpha mask to the texture of the cube faces. In some cases, the data processing system 1202 can initiate binary searching along the distance between dots, and draw lines to the edge of the face for as many faces involved as necessary. Upon identifying the doors, the data processing system 1202 can provide animations for the outline of the door. The data processing system 1202 can provide a set of sprites, such as a computer graphic that can be moved on-screen or otherwise manipulated as a single entity. The data processing system 1202 can provide the set of sprites around the door outline to form the frame of the door. The data processing system 1202 can scale the animation logic in size or opacity.

The data processing system 1202 can include a camera bearing controller 1268 designed, constructed and operational to establish a camera pose or bearing to facilitate panoramic connection. The camera bearing controller 1268 can determine the camera bearing or pose given a current registration as indicated by another image. The camera bearing controller 1268 can be configured with a pose extraction technique that can compare two subsequent images to identify the camera position for the first image based on the subsequent image. The camera bearing controller 1268 can be configured with a panoramic image function that can process spherical or epipolar geometry of the images.

The data processing system 1202 can include characteristic generator 1260 designed, constructed and operational to automatically generate characteristics for the connected set of images and for inclusion in the virtual tour. The characteristic generator 1260 can use the features detected by the image feature detector 1266 to generate a virtual tour with an animation that steps through the sequence of images to provide a linear direction. The data processing system 1202 can store the generator virtual tour in the virtual tour data repository 1248 and/or the data repository 1214. The characteristic generator 1260 can initialize the virtual tour with an automated camera pan at one or more sides. The characteristic generator 1260 can identify a direction of the camera path and generate chevrons or other icons to embed of overlay on the camera path in the virtual tour that correspond to the direction. The characteristic generator 1260 can provide for interactivity with the virtual tour, such as the ability for the user to pause the virtual tour, go forwards or backwards, pan left or right, lean-back or lean forward. The characteristics can include sprites for the door frame outline, for example.

The virtual tour interface system 1240 can include an authoring tool 1246 designed, constructed and operational to allow for interactive authoring, persisting, or replaying a camera position for each panoramic image. A user can interface with the authoring tool 1246 via a graphical user interface (not shown). The virtual tour interface system 1240, or authoring tool 1246, can provide a graphical user interface accessible by a client device (not shown), for example. Using the graphical user interface, a user (or content provider, or administrator) can tag hot spots in a room corresponding to the images. The user can author a separate path based on a panoramic path, create or input metadata for the panoramic path, or establish default turns. The user can provide or integrate logos into the images for presentation with the virtual tour. The logo can be integrated within the visible viewer context.

The data processing system 1202 can include a viewer delivery controller 1262 designed, constructed and operational to provide a virtual tour for rendering via a viewer application (not shown) on a client device (not shown). The viewer delivery controller 1262 can receive a request from a client device for a viewer application or virtual tour. For example, a client application (e.g., a web browser) executing on the client device (e.g., a mobile phone) can make a call or request to the data processing system 1202 for a viewer. The call can be made via JavaScript or iFrame to the data processing system 1202. The viewer delivery controller 1262 can receive the JavaScript or iFrame call or request. The viewer delivery controller 1262 can provide a viewer application (not shown) to the client device. The viewer delivery controller 1262 can provide the viewer application responsive to the request or call received from the client device via the network 101.

The viewer delivery controller 1262 can provide the virtual tour to the viewer application for playback on the client application or client device. The virtual tour can include or be based on the internal image data or metadata. The viewer application executing on the client device can download the virtual tour or other panoramic image data for playback or rendering on the client device.

Referring to FIG. 12, the data repository 1214 can include or store a session ID data structure 1216, a blockchain map data structure 1218, an asset data 1220, and/or a geographic regions data structure 1222.

Referring to FIG. 12, the session ID data structure 1216 of the data repository 1214 can include or store session identifiers. Session identifiers can refer to a unique session identifier that is provided or generated by the data processing system 1202. The session can refer to an asset registration session. For example, an asset can be a panoramic image of a room. In a session, the panoramic image can be registered on a digitally distributed, decentralized, public or private ledger (“ledger”), such as a public blockchain. Once registered, the panoramic image has been tokenized. For example, the panoramic image can be a non-fungible token (“NFT”). In another example, the asset can be a sequence of static images. In another example, the asset can be a virtual tour, which is a seamless configuration of a plurality of images than can be played in parts like an interactive video. The session can be initiated responsive to a request from a virtual tour interface system 1240, discussed more below. The session can be initiated by the data processing system 1202.

The blockchain map data structure 1218 can include or store a ledger, e.g., a blockchain, address assigned to an asset. A blockchain address can refer to or include a secure identifier. For example, the data processing system 1202 can assign or otherwise associate a unique blockchain address to each image, sequence of images, and/or virtual tours created. The blockchain map data structure 1218 can include a unique identifier for the image, sequence of images, and/or virtual tours. The blockchain map data structure 1218 can map, link, or otherwise associate the unique identifier for the image, sequence of images, and/or virtual tours with the blockchain address assigned to the image, sequence of images, and/or virtual tours. The unique identifier can refer to or include an alphanumeric identifier assigned to the image, sequence of images, and/or virtual tours, such as a 10-digit number.

The asset data 1220 can include one or more software programs or data files. The asset data 1220 can include metadata associated with a software program. The asset data 1220 can include, for example, asset registration data files, executable files, time and data stamps associated with registration of the asset, provider of the asset, or status information associated with the asset registration. The asset data 1220 can include instructions as to which assets are to be registered. The asset data 1220 can include information about the registration, such as registration requirements. The asset data 1220 can include criteria for when to register the asset/s, such as overnight, a specific day and/or time, or geographic locations of the asset subject, such as the location of the building a virtual tour is of. The asset data 1220 can include a history of the asset registration.

The geographic regions data structure 1222 can include information about which assets with subjects in specific geographic regions are authorized for registration. For example, an asset can be a virtual tour of a subject, such as a hotel. The hotel can be located in a geographic region, such as Florida. The geographic regions data structure 1222 can provide that all assets with subjects in Florida are authorized for registration. The geographic regions data structure 1222 can include historical information about asset registrations. Geographic regions can include geographic locations of a subject of an asset when the asset was registered. A geographic location (e.g., latitude, longitude or street address) can map to a larger geographic region (e.g., a geographic tile, city, town, county, zip code, state, country, or other territory). The geographic regions data structure 1222 can include information about successful and unsuccessful registrations.

Referring to FIG. 12, the geographic regions data structure 1222 can include information about servers or data centers associated with the successful or unsuccessful registrations. The geographic regions data structure 1222 can also include network addresses (e.g., IP addresses) associated with the servers or data centers.

Referring to FIG. 12, the data processing system 1202 can include a blockchain register 1204. The blockchain register 1204 can perform the asset registration. Once registered, there is a ledger, e.g., a blockchain, address assigned to the asset, which is stored in the blockchain map data structure 1218. For example, an asset can be a panoramic image of a room. The panoramic image can be registered on a digitally distributed, decentralized, public or private ledger (“ledger”), such as a public blockchain. Once registered, the panoramic image has been tokenized. For example, the panoramic image can be a non-fungible token (“NFT”). In another example, the asset can be a sequence of connected panoramic images. The sequence of connected panoramic images can be registered on a ledger, such that the sequence of connected panoramic images are tokenized and the sequence is an NFT. In another example, the asset can be a virtual tour, which is a seamless configuration of a plurality of images than can be played in parts like an interactive video. The virtual tour can be registered on a ledger, such that the virtual tour is tokenized and the virtual tour is an NFT. In another embodiment, the asset can be an image, sequence of images, and/or virtual tour with other media, such as audio or video. For example, an asset can be a virtual tour with audio guiding the tour. In another embodiment, the asset can be an image, sequence of images, and/or virtual tour with location metadata. For example, an asset can be a panoramic image with location metadata associated with a location identification coordinate onto a private or public ledger. The location identification coordinate can include a reference to an appropriate and available viewing system. The asset registration can be initiated responsive to a request from a virtual tour interface system 1240, discussed more below. The asset registration can be initiated by the data processing system 1202.

The blockchain register 1204 can register an asset, such as an aggregated number of sequences of images, to create locations and connections that can be referenced. Connections can be a connection of individual images. Connections can be a connection of a third party database, such as a third party maps, and an internal database. For example, an asset can be a virtual tour that connects images of a third party maps database of the outside of a structure (e.g., the subject of the tour) and images of an internal database of the inside of the same structure. In another example, an asset can be a virtual tour of a structure, such as a hotel, that includes its location data, such as its address. Thus, the location data of the subject of the virtual tour (e.g., the structure) is registered with the virtual tour and can be referenced when the virtual tour is referenced.

The data processing system 1202 can include an asset caller 1206. The asset caller 1206 can call to the ledger, e.g., blockchain, to reference an asset that has been registered. The asset caller 1206 can access the ledger, e.g., a blockchain, address assigned to an asset, which is stored in the blockchain map data structure 1218. The asset caller 1206 can use the ledger, e.g., a blockchain, address to call the ledger. Since the ledger address is unique to each asset, the asset caller 1206 can reference the specific asset it calls.

The data processing system 1202 can include a sequence builder 1208. The sequence builder 1208 can build and rebuild sequences of images. The sequence builder 1208 can use, include, leverage or access one or more component or functionality of image iterator 1264, image feature detector 1266, camera bearing controller 1268, characteristic generator 1260, or viewer deliver controller 1262 to build or rebuild a sequence of images. The images can be stored on an internal database and accessed by the data processing system 1202. The sequence builder 1208 can build a sequence of images. For example, the sequence builder 1208 can access images stored on an internal database and compile all of them into a sequence. The sequence builder 1208 can rebuild a sequence of images based on an algorithmic ruleset, which can also be registered and stored on a ledger. For example, the sequence builder 1208 can rebuild a sequence based on an algorithmic ruleset that includes a rule for adding audio to the original sequence of images. The rebuilt sequence can be the same as the original sequence of images. The rebuilt sequence can be different from the original sequence of images. For example, the rebuilt sequence of images can be shorter and not include the first image in the original sequence of images. In another example, the rebuilt sequence of images can be longer than the original sequence of images and include additional images.

The sequence builder 1208 can connect panoramic images to provide automatic play functionality with one or more transitions. The sequence builder 1208 can automatically associate a visual position and direction between correlative panoramic images or video media to generate a smooth, seamless camera path between the different panoramic images. The sequence builder 1208 can use the generated camera path to provide a virtual tour. Thus, the sequence builder 1208 can connect independent panoramic images (or video media) into a cohesive experience that is based on a cohesive set of rules. The connected independent panoramic images can be characterized as an asset and can be registered on a ledger.

Still referring to FIG. 12, and in further detail regarding generating a virtual tour, the data processing system 1202 can include an image iterator 1204 designed, constructed and operational to surface key data sets from image-level noise. The image iterator 1204 can be configured with one or more techniques to identify key data sets from the image-level noise. The image iterator 1204, using these techniques, can create a directional connection between the images. For example, the image iterator 1204 can access image data 1214 stored in database 1214, process the images to remove image-level noise, and then determine a directional connection between the images. A directional connection can refer to a camera path or transition from a first image to a second image. The image iterator 1204 can control and persist a digital camera position through the panoramic connection set.

The image iterator 1204 can establish, set, generate or otherwise provide image transitions for the virtual tour. The data processing system can build visual image transitions during the creation of the virtual tour. To do so, the data processing system 1202 can use a tweened animation curve. A tweened animation curve can include generating intermediate frames between two frames in order to create the illusion of movement by smoothly transitioning one image to another. The data processing system 1202 can use the tweened animation curve to increase or maximize the sense of forward motion between images, relative to not using tweened animations.

The image iterator 1204 can perform tweening in a manner that preserves the spatial orientation. For example, the data processing system 1202 can position a virtual camera at an entrance of a cube, such as a second cube. The data processing system 1202 can move a previous scene forwards and past the viewer while fading out, and move the second scene in (e.g., overlapping) while fading in. This overlap can correspond to, refer to, represent, or symbolize linear editing techniques. For a door transition, the data processing system 1202 can fade the door as the viewer passes through the door.

The data processing system 1202 can include an NFT attributer 1209. The NFT attributer 1209 can track how many times a registered asset is accessed, referenced, or called. For example, a registered asset, e.g., an NFT, can be a virtual tour of a restaurant and the NFT attributer 1209 can monitor the number of times the virtual tour is accessed and viewed. The NFT attributer 1209 can notify the owner of the asset how many times the virtual tour was accessed. The information regarding the owner of the NFT can be stored on the ledger and also in the data repository 1214.

The data processing system 1202 can include an NFT updater 1210. The NFT updater 1210 can update attributes of the registered asset, e.g., the NFT. For example, if the asset is a virtual tour of an office building and a room in the office building is redesigned, then the NFT updater 1210 can update specific parts of the virtual tour to include the redesigned room. In another example, if the asset is a tour of an office building that has a sign on the door, the NFT updater 1210 can access and use a third party application, such as a third party photo editor, to edit the original panoramic image and remove the sign on the door. The NFT updater 1210 can be blocked by the NFT owner from updating the NFT. The NFT updater 1210 can require permission from the NFT owner before updating the NFT.

The data processing system 1202 can include a data authenticator 1211. The data authenticator 1211 can validate the image data that makes up the assets, e.g., images, sequences of images, and virtual tours. The data authenticator 1211 can validate the image data of the assets with a rights table. The data authenticator 1211 can validate the image data of the assets with a permissions table.

The data processing system 1202 can include a location associator 1212. The location associator 1212 can bind a given location with other locations or groups of locations by default. For example, location data such as an address can be bound with other addresses that share a zip code.

The data processing system 1202 can include an interface 1258 designed, configured, constructed, or operational to receive and transmit information. The interface 1258 can receive and transmit information using one or more protocols, such as a network protocol. The interface 1258 can include a hardware interface, software interface, wired interface, or wireless interface. The interface 1258 can facilitate translating or formatting data from one format to another format. For example, the interface 1258 can include an application programming interface that includes definitions for communicating between various components, such as software components. The interface 1258 can be designed, constructed or operational to communicate with one or more virtual tour interface systems 1240 to perform asset registration. The interface 1258 can be designed, constructed or operational to communicate with one or more blockchain systems 1224 to conduct a blockchain transaction or store information in one or more blocks 1230 of a blockchain record 1228. The interface 1258 can communicate with the blockchain system 1224 via a blockchain API.

The interface 1258 can receive a request from the virtual tour interface system 1240. The request can include information, such as what it is a request for, time stamps, asset identification information or other information. The request can include a request to perform an asset registration. The interface 1258 can receive the request via network 101.

Each of the components of the data processing system 1202 can be implemented using hardware or a combination of software and hardware. Each component of the data processing system 1202 can include logical circuitry (e.g., a central processing unit or CPU) that responses to and processes instructions fetched from a memory unit (e.g., memory 315 or storage device 325). Each component of the data processing system 1202 can include or use a microprocessor or a multi-core processor. A multi-core processor can include two or more processing units on a single computing component. Each component of the data processing system 1202 can be based on any of these processors, or any other processor capable of operating as described herein. Each processor can utilize instruction level parallelism, thread level parallelism, different levels of cache, etc. For example, the data processing system 1202 can include at least one logic device such as a computing device or server having at least one processor to communicate via the network 101. A data processing system 1202 can communicate with one or more data centers, servers, machine farms or distributed computing infrastructure.

The components and elements of the data processing system 1202 can be separate components, a single component, or part of the data processing system 1202. For example, the blockchain register 1204, asset caller 1206, sequence builder 1208, NFT attributer 1209, NFT updater 1210, data authenticator 1211, location associator 1212 (and the other elements of the data processing system 1202) can include combinations of hardware and software, such as one or more processors configured to perform asset registration, for example. The components of the data processing system 1202 can be hosted on or within one or more servers or data centers. The components of the data processing system 1202 can be connected or communicatively coupled to one another. The connection between the various components of the data processing system 1202 can be wired or wireless, or any combination thereof.

The system 1200 can include, interface, communicate with or otherwise utilize a virtual tour interface system 1240. The virtual tour interface system 1240 can include at least one verification component 1242, at least one blockchain interface component 1244, an authoring tool 1246, discussed above, and at least one virtual tour data repository 1248. The virtual tour data repository 1248 can include or store a unique ID 1250, a sequence 1252, and an image 1254.

The unique ID 1250 can include or store the unique identifier of the asset, such as an alphanumeric identifier assigned to the asset or blockchain address assigned to the asset. The sequence 1252 can include or store the sequences of images and/or virtual tours that are or can be in the future a registered asset. The image 1254 can include or store images, including panoramic images, which are or can be in the future a registered asset.

The virtual tour interface system 1240 can be a part of the data processing system 1202, or a separate system configured to access, communicate, or otherwise interface with the data processing system 1202 via network 101. The virtual tour interface system 1240 can include at least one verification component 1242. The verification component 1242 of the virtual tour interface system 1240 can verify the image and location data of potential assets, e.g., the images, sequences of images, and/or virtual tours. The verification component 1242 of the virtual tour interface system 1240 can verify the image and location data of existing assets, e.g., the images, sequences of images, and/or virtual tours. For example, the verification component 1242 can confirm that images taken of structure, such as a hotel, match with the address of the structure, such that it is verified that the images are of that structure. The verification component 1242 can access the certification of a photographer who provides image data of a potential and/or existing asset by accessing an internal database (not shown). The verification component 1242 can confirm the owner of a structure by accessing a third party database (not shown). The verification component 1242 can confirm the owner of a registered asset by accessing the information stored in the session ID 1216 and blockchain map data structure 1218 of the data repository 1214. The verification component 1242 can also confirm the owner of a registered asset by accessing the blockchain system 1224, discussed below.

The virtual tour interface system 1240 can include at least one blockchain interface component 1244. The verification component 1242 can invoke, launch, access, execute, call or otherwise communicate with the blockchain interface component 1244 to query the blockchain system 1224. The blockchain interface component 1244 can include one or more component or functionality of the interface 1258 used to interface with the blockchain system 1224, such as a blockchain API. The blockchain interface component 1244 can construct the query using the blockchain address of the registered asset or registered assets stored in the unique ID 1250 of the virtual tour data repository 1248. For example, the blockchain interface component 1244 of the virtual tour interface system 1240 can be configured with a query language or REST APIs configured to query the blockchain for information such as transaction data (e.g., digital signature) in blocks (e.g., block 1226). The blockchain interface component 1244 can communicate with one or more nodes 1226 in the blockchain system 1224 to obtain the digital signature stored in block 1226. For example, the blockchain interface component 1244 can obtain the digital signature stored in block 1226 responsive to a certain percentage (e.g., 25%, 30%, 40%, 50%, 51%, 60%, 70% or more) of the nodes 1226 in the blockchain system 1224 verifying the data stored in block 1226 on each of the respective nodes 1226.

The blockchain interface component 1244 can receive a response from the blockchain system 1224 (or a node 1226 thereof) that includes the digital signature from block 1226, which was previously stored in block 1226 by the data processing system 1202. The verification component 1242 can receive the digital signature via the blockchain interface component 1244. The verification component 1242 can parse the digital signature to identify a session ID and a ledger address. For example, if the digital signature was generated using a bidirectional encryption function, then the verification component 1242 can use a decryption function that corresponds to the encryption function in order to decrypt the digital signature and identify the session ID and ledger address stored therein. Example bidirectional encryption functions (or two-way encryption functions or reversible encryption function) used by the data processing system 1202 to generate the digital signature can include a symmetric key encryption. The session ID can be stored in the digital signature by the data processing system 1202.

The verification component 1242 can compare the session ID received from the digital signature received from the block 1226 with the session ID received from the blockchain register 1204 (that registered the asset) of the data processing system 1202. If the session IDs match then the verification component 1242 can determine that the asset data file received from the data processing system 1202 is the same as the asset data transmitted by the data processing system 1202 (e.g., not altered). The verification component 1242 can use one or more techniques to determine the match. For example, the verification component 1242 can use various comparison techniques, including, for example, machine learning, comparison algorithms such as server-side data comparison using the resources of the server, local data comparison with comparison results stored in RAM, or local data comparison with comparison results stored as a cached file on the disk. The verification component 1242 can be configured with various comparison techniques, including, for example, comparison tools such as dbForge Data Compare for SQL Server, dbForge Data Compare for MySQL, dbForge Data Compare for Oracle, or dbForge Data Compare for PostgreSQL.

Each of the components of the virtual tour interface system 1240 can be implemented using hardware or a combination of software and hardware. Each component of the virtual tour interface system 1240 can include logical circuitry (e.g., a central processing unit or CPU) that responses to and processes instructions fetched from a memory unit (e.g., memory 315 or storage device 325). Each component of the virtual tour interface system 1240 can include or use a microprocessor or a multi-core processor. A multi-core processor can include two or more processing units on a single computing component. Each component of the virtual tour interface system 1240 can be based on any of these processors, or any other processor capable of operating as described herein. Each processor can utilize instruction level parallelism, thread level parallelism, different levels of cache, etc. For example, the virtual tour interface system 1240 can include at least one logic device such as a computing device or server having at least one processor to communicate via the network 101. A virtual tour interface system 1240 can communicate with one or more data centers, servers, machine farms or distributed computing infrastructure.

The components and elements of the virtual tour interface system 1240 can be separate components, a single component, or part of the virtual tour interface system 1240. For example, the verification component 1242, and the blockchain interface component 1244 (and the other elements of the virtual tour interface system 1240) can include combinations of hardware and software, such as one or more processors configured to perform asset registration, for example. The components of the virtual tour interface system 1240 can be hosted on or within one or more computing systems. The components of the virtual tour interface system 1240 can be connected or communicatively coupled to one another. The connection between the various components of the virtual tour interface system 1240 can be wired or wireless, or any combination thereof.

The system 1200 can include a blockchain system 1224. The blockchain system 1224 can include, be composed of, or otherwise utilize multiple computing nodes 1226. The blockchain system 1224 can include, be composed of, or otherwise utilize a blockchain record 1228, which can include one or more blocks 1230, 1232, 1234 and 1236. The data processing system 1202 or virtual tour interface system 1240 can interface, access, communicate with or otherwise utilize a blockchain system 1224 to perform asset registration.

The computing nodes 1226 can include one or more component or functionality of computing device 300 depicted in FIG. 3. The blockchain system 1224 can generate, store or maintain a blockchain record 1228. The blockchain record 1228 can correspond to a blockchain, e.g., ledger, address, such as the blockchain address assigned to a registered asset. The blockchain record 1228 can include one or more blocks 1230, 1232, 1234 and 1236. The blocks in the blockchain can refer to or correspond to a blockchain transaction. The blockchain system 1224 can include a distributed network of nodes 1226 (e.g., computing systems or computing devices) that store the blockchain record 1228 having a blockchain address assigned to the registered asset. Each block (e.g., 1230, 1232, 1234 or 1236) at the blockchain record 1228 can include a cryptographic hash of a previous block in the blockchain record 1228.

A blockchain can refer to a growing list of records (or blocks) that are linked and secured using cryptography. Each block (e.g., 1230, 1232, 1234 or 1236) can include a cryptographic hash of a previous block as well as contain content or other data. For example, block 1236 can include a cryptographic hash of block 1234; block 1234 can include a cryptographic hash of block 1232; block 1232 can include a cryptographic hash of block 1232; and block 1232 can include a cryptographic hash of block 1230. The blockchain can be resistant to modification of the data stored in the block. The blockchain can be an open, distributed record of electronic transactions. The blockchain record 1228 can be distributed among the computing nodes 1226. For example, each computing node 1226 can store a copy of the blockchain record 1228. The computing nodes 1226 can refer to or form a peer-to-peer network of computing nodes collectively adhering to a protocol for inter-node communication and validating new blocks of the blockchain record 1228. Once recorded, the data in any given block (e.g., 1230, 1232, 1234, or 1236) cannot be altered retroactively without alteration of all subsequent blocks, which requires collusion of the majority of the computing nodes 1226.

By maintaining the blockchain record 1228 in a decentralized, distributed manner over the network formed by computing nodes 1226, the record cannot be altered retroactively without the alteration of all subsequent blocks and the collusion of the network. The blockchain database (e.g., blockchain record 1228) can be managed autonomously using the peer-to-peer network formed by computing nodes 1226, and a distributed timestamping server.

Each block 1230, 1232, 1234 or 1236 in the blockchain record 1228 can hold valid transactions that are hashed and encoded into a hash tree. Each block includes the cryptographic hash of the prior block in the blockchain, linking the two. The linked blocks 1230, 1232, 1234 and 1236 form the blockchain record 1228. This iterative process can confirm the integrity of the previous block, all the way back to the original genesis block (e.g., block 1230).

Referring to FIG. 12, the network 101 can provide for communication or connectivity between the data processing system 1202, virtual tour interface system 1240 and blockchain system 1224. The network 101 can include computer networks such as the internet, local, wide, near field communication, metro or other area networks, as well as satellite networks or other computer networks such as voice or data mobile phone communications networks, and combinations thereof. The network 101 can include a point-to-point network, broadcast network, telecommunications network, asynchronous transfer mode network, synchronous optical network, or a synchronous digital hierarchy network, for example. The network 101 can include at least one wireless link such as an infrared channel or satellite band. The topology of the network 101 can include a bus, star, or ring network topology. The network 101 can include mobile telephone or data networks using any protocol or protocols to communicate among other devices, including advanced mobile protocols, time or code division multiple access protocols, global system for mobile communication protocols, general packet radio services protocols, or universal mobile telecommunication system protocols, and the same types of data can be transmitted via different protocols.

The data processing system 1202 can provide the digital signature for storage in a block 1226 or record at the blockchain record 1228. The data processing system 1202 can provide the digital signature to the blockchain system 1224 with an indication of the blockchain address corresponding to the registered asset. The blockchain system 1224 can generate a new block (e.g., block 1226) in the blockchain record 1228 and store the digital signature in the new block 1226. The blockchain system 1224 can provide an indication to the data processing system 1202 that the new block 1226 was successfully created and stored the digital signature generated by the data processing system 1202.

The data processing system 1202 (e.g., interface 1258) can receive an indication that the digital signature was stored in the block 1226 at the blockchain record 1228. The data processing system 1202 can transmit the session identifier to the registered asset responsive to the indication that the digital signature was stored in the block 1226 at the blockchain record 1228.

FIG. 13 depicts an example method of performing registration of and reference to images and/or a sequence of images on a digitally distributed, decentralized, public or private ledger, in accordance with an embodiment. The method 1300 can be performed be one or more system or component depicted in FIG. 12 or FIG. 3, including for example a data processing system, virtual tour interface system, or blockchain system.

Still referring to FIG. 13, and in further detail, the method 1300 can include creating an image sequence at 1302. The image sequence can be a sequence of static images. The image sequence can be a virtual tour, which can include a seamless configuration of a plurality of images than can be played in parts like an interactive video. The sequence builder 1208 of FIG. 12, can connect panoramic images to provide automatic play functionality with one or more transitions. The sequence builder 1208 can automatically associate a visual position and direction between correlative panoramic images or video media to generate a smooth, seamless camera path between the different panoramic images. The sequence builder 1208 can use the generated camera path to provide a virtual tour. Thus, the sequence builder 1208 can connect independent panoramic images (or video media) into a cohesive experience that is based on a cohesive set of rules. The connected independent panoramic images can be characterized as an asset and can be registered on a ledger.

At 1304, the method can include registering an image sequence and/or individual images on a digitally distributed, decentralized, public or private ledger, such as a blockchain. The blockchain register 1204 of FIG. 12 can register assets, e.g., an image sequence and individual images. The assets are registered on a ledger, for example a blockchain. Once registered, there is a ledger, e.g., a blockchain, address assigned to the asset, which is stored in the blockchain map data structure 1218. The registered asset is now an NFT. For example, the asset can be a virtual tour, which is a seamless configuration of a plurality of images than can be played in parts like an interactive video. The virtual tour can be registered on a ledger, such that the virtual tour is tokenized and the virtual tour is an NFT. This step of the method can include the blockchain register 1204 registering an asset, such as an aggregated number of sequences of images, to create locations and connections that can be referenced.

At 1306, the method 1300 can include storing the individual images and/or image sequences on a large-scale server that supports the ledger files, such as IPFS, AWS, or a similar server. The data processing system 1202 is in communication with the blockchain system 1224 and the virtual tour interface system 1240. The individual images and/or image sequences that are stored can be stored in the data repository 1214 of the data processing system 1202. The individual images and/or image sequences that are stored can be stored in the virtual tour data repository 1248 of the virtual tour interface system 1240.

At 1308, the method can include referencing the individual images and/or image sequences as appropriate by making calls to the ledger. The asset caller 1206 of the data processing system 1202 can make calls to the ledger. The asset caller 1206 can call to the ledger, e.g., blockchain, to reference an asset that has been registered. The asset caller 1206 can access the ledger address assigned to an asset, which is stored in the blockchain map data structure 1218. The asset caller 1206 can use the ledger address to call the ledger. Since the ledger address is unique to each asset, the asset caller 1206 can reference the specific asset it calls.

At 1310, the method includes making attributions to the owner of the individual images and/or image sequences. The NFT attributer 1209 of the data processing system 1202 can track how many times a registered asset is accessed, referenced, or called. For example, a registered asset, e.g., an NFT, can be a virtual tour of a restaurant and the NFT attributer 1209 can monitor the number of times the virtual tour is accessed and viewed. The NFT attributer 1209 can notify the owner of the asset how many times the virtual tour was accessed. The information regarding the owner of the NFT can be stored on the ledger and also in the data repository 1214.

Some of the description herein emphasizes the structural independence of the aspects of the system components illustrates one grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

What is claimed is:

1. A system to connect outdoor-to-indoor panoramic data, comprising:
a data processing system comprising one or more processors, coupled with memory, to:
identify, in a data repository, a virtual tour of an internal portion of a physical building formed from a plurality of images connected with a linear path along a persistent position of a virtual camera;
receive, from a third-party data repository, image data corresponding to an external portion of the physical building;
detect, within the image data, an entry point for the internal portion of the physical building;
generate, responsive to the detection of the entry point, a step-in transition at the entry point in the image data;
connect the virtual tour with the step-in transition generated for the image data at the entry point; and
initiate, on a client device responsive to an interaction with the entry point, the step-in transition to cause a stream of the virtual tour.

2. The system of claim 1, wherein the data processing system is further configured to:
determine a location of the physical building of the virtual tour;
query the third-party data repository with the location; and
receive, from the third-party data repository, the image data responsive to the query.

3. The system of claim 1, wherein the data processing system is further configured to:
identify a plurality of entry points in the image data; and
provide a prompt to a second client device to select one entry point from the plurality of entry points for which to generate the step-in transition.

4. The system of claim 1, wherein the data processing system is further configured to:
cast rays to corner points of one or more doors in the image data to identify a cube face of a plurality of cube faces; and
assign the entry point to a door of the one or more doors corresponding to the identified cube face of the plurality of cube faces.

5. The system of claim 4, wherein the data processing system is further configured to:
provide, responsive to selection of the door of the one or more doors, a set of sprites to form an outline for the door;
generate a step-in animation for the step-in transition based on the set of sprites; and
integrate the step-in animation with the virtual tour.

6. The system of claim 5, wherein the data processing system is further configured to:
overlay an icon on the image data to generate the step-in animation.

7. The system of claim 1, wherein the data processing system is further configured to:
deliver, responsive to the interaction with the entry point by the client device, a viewer application that executes in a client application on the client device; and
stream, to the viewer application, the virtual tour to cause the viewer application to automatically initiate playback of the virtual tour upon receipt of the streamed virtual tour.

8. The system of claim 1, wherein the data processing system is further configured to:
receive, from the third-party data repository, data corresponding to the external portion of the physical building;
iterate through the data from the third-party data repository to identify key datasets from image-level noise in the data; and
correlate the plurality of images from the data repository with the key datasets of the third-party data repository to identify the image data comprising the entry point.

9. The system of claim 8, wherein the data processing system is further configured to:
use machine learning to correlate the plurality of images of the data repository with the key datasets of the third-party data repository to identify the image data comprising the entry point.

10. The system of claim 1, wherein the data processing system is further configured to:
identify a door in the image data based on machine learning with saved images; and
detect the entry point as the door.

11. A method of connecting outdoor-to-indoor panoramic data, comprising:
identifying, by a data processing system comprising one or more processors coupled with memory, in a data repository, a virtual tour of an internal portion of a physical building formed from a plurality of images connected with a linear path along a persistent position of a virtual camera;
receiving, by the data processing system from a third-party data repository, image data corresponding to an external portion of the physical building;
detecting, by the data processing system within the image data, an entry point for the internal portion of the physical building;
generating, by the data processing system responsive to the detection of the entry point, a step-in transition at the entry point in the image data;
connecting, by the data processing system, the virtual tour with the step-in transition generated for the image data at the entry point; and
initiating, by the data processing system on a client device responsive to an interaction with the entry point, the step-in transition to cause a stream of the virtual tour.

12. The method of claim 11, comprising:
determining, by the data processing system, a location of the physical building of the virtual tour;
querying, by the data processing system, the third-party data repository with the location; and
receiving, by the data processing system from the third-party data repository, the image data responsive to the query.

13. The method of claim 11, comprising:
identifying, by the data processing system, a plurality of entry points in the image data; and
providing, by the data processing system, a prompt to a second client device to select one entry point from the plurality of entry points for which to generate the step-in transition.

14. The method of claim 11, comprising:
casting, by the data processing system, rays to corner points of one or more doors in the image data to identify a cube face of a plurality of cube faces; and
assign the entry point to a door of the one or more doors corresponding to the identified cube face of the plurality of cube faces.

15. The method of claim 14, comprising:
providing, by the data processing system responsive to selection of the door of the one or more doors, a set of sprites to form an outline for the door;
generating, by the data processing system, a step-in animation for the step-in transition based on the set of sprites; and
integrating, by the data processing system, the step-in animation with the virtual tour.

16. The method of claim 15, comprising:
overlaying, by the data processing system, an icon on the image data to generate the step-in animation.

17. The method of claim 11, comprising:
delivering, by the data processing system responsive to the interaction with the entry point by the client device, a viewer application that executes in a client application on the client device; and
streaming, by the data processing system to the viewer application, the virtual tour to cause the viewer application to automatically initiate playback of the virtual tour upon receipt of the streamed virtual tour.

18. The method of claim 11, comprising:
receiving, by the data processing system from the third-party data repository, data corresponding to the external portion of the physical building;
iterating, by the data processing system, through the data from the third-party data repository to identify key datasets from image-level noise in the data; and
correlating, by the data processing system, the plurality of images from the data repository with the key datasets of the third-party data repository to identify the image data comprising the entry point.

19. A non-transitory computer readable medium storing processor-executable instructions that, when executed by one or more processors, cause the one or more processors to:
identify, in a data repository, a virtual tour of an internal portion of a physical building formed from a plurality of images connected with a linear path along a persistent position of a virtual camera;
receive, from a third-party data repository, image data corresponding to an external portion of the physical building;
detect, within the image data, an entry point for the internal portion of the physical building;
generate, responsive to the detection of the entry point, a step-in transition at the entry point in the image data;
connect the virtual tour with the step-in transition generated for the image data at the entry point; and
initiate, on a client device responsive to an interaction with the entry point, the step-in transition to cause a stream of the virtual tour.

20. The non-transitory computer readable medium of claim 19, wherein the instructions further comprise instructions to:
determine a location of the physical building of the virtual tour;
query the third-party data repository with the location; and
receive, from the third-party data repository, the image data responsive to the query.
